(19) United States
(12) Patent Application Publication
(10) Pub. No.: US 2024/0128514 A1
(43) Pub. Date: Apr. 18, 2024

(54) ULTRA-HIGH-VOLTAGE RECHARGEABLE BATTERIES WITH SULFONAMIDE-BASED ELECTROLYTES

(71) Applicant: Massachusetts Institute of Technology, Cambridge, MA (US)

(72) Inventors: Yang Shao-Horn, Newton, MA (US); Ju LI, Weston, MA (US); Jeremiah Johnson, Boston, MA (US); Wenxu Zhang, Belmont, MA (US); Mingjun Huang, Everett, MA (US); Weijiang XUE, Chestnut Hill, MA (US); Yanhao Dong, Hefei (CN)

(73) Assignee: Massachusetts Institute of Technology, Cambridge, MA (US)

(21) Appl. No.: 18/547,123

(22) PCT Filed: Feb. 18, 2022
(86) PCT No.: PCT/US2022/017013

§ 371 Date: Aug. 18, 2023

Related U.S. Application Data
(60) Provisional application No. 63/150,816, filed on Feb. 18, 2021.

(51) Int. Cl. H01M 10/0569; H01M 4/505; H01M 4/525; H01M 10/052; H01M 10/0567; H01M 10/0568; H01M 10/44

(52) U.S. Cl. CPC H01M 10/0569; H01M 4/505; H01M 4/525; H01M 10/052; H01M 10/0567; H01M 10/0568; H01M 10/446; H01M 2004/028

(57) ABSTRACT

An electrochemical device includes a transition metal oxide cathode, such as LiNi0.8Co0.1Mn0.1O2, and an electrolyte. The electrolyte includes N, N-dimethyltrifluoromethane-sulfonamide (DMTMSA) and lithium bis(fluorosulfonyl)imide (LiFSI). The DMTMSA and LiFSI may be either the primary component of the electrolyte or an additive in the electrolyte. The electrochemical device may also include a graphite anode or a lithium metal anode. With a lithium metal anode, the electrochemical device has an initial specific capacity of at least 231 mAh g⁻¹. Over at least 100 cycles (upper cut-off voltage of 4.7±0.05 V vs. Li/Li⁺), the electrochemical device maintains an average specific capacity of at least 88% of the initial specific capacity and an average Coulombic efficiency of at least about 99.65%.

### CROSS-REFERENCE TO RELATED PATENT APPLICATION(S)

The present application claims priority to U.S. provisional application No. 63/150,816, filed on Feb. 18, 2021, entitled “LiFSI/DMTMSA Electrolyte Suppresses Stress-Corrosion of 4.7Volt NMC Cathodes and Enables Practical Li Batteries,” which is incorporated herein by reference in its entirety.

### GOVERNMENT SUPPORT

This invention was made with Government support under Grant No. ECCS 1610806 awarded by The National Science Foundation (NSF). The Government has certain rights in the invention.

### BACKGROUND

There is an urgent demand for higher energy-density batteries (e.g., >400 Wh kg⁻¹) for many different battery applications, including portable electronic devices, drones, and electric vehicles. However, electrochemical cycling of high-energy-density cathodes (e.g., high-nickel cathodes, LiNiₓMn_{y}Co_{1-x-y}O₂) at high charging voltages (e.g., >4.55 V) is conventionally unstable, leading to very short cycle lives. The instability results from high electrochemical reactivity and unstable electrode-electrolyte interfaces in these conditions. Lithium metal anodes (LMAs) can also greatly increase energy density, but also conventionally suffer from low cycling stability.

### SUMMARY

Disclosed herein is a sulfonamide-based electrolyte facilitates stable cycling in electrochemical devices (e.g., lithium-ion batteries, lithium metal batteries, solid-state batteries, or flow batteries). The sulfonamide-based electrolyte with LiTFSI and/or LiFSI salts has excellent oxidation resistance and forms favorable sold-electrolyte interfaces with high-voltage cathodes. For example, the sulfonamide-based electrolyte facilitates stable cycling of commercial LiNi_{0.8}Co_{0.1}Mn_{0.1}O₂ with a cut-off voltage up to 4.7±0.05 V in lithium metal batteries (LMBs). In contrast to commercial carbonate electrolytes, the electrolyte disclosed herein not only suppresses side reactions, intergranular cracking, transition-metal dissolution, and impedance growth on the cathode side, but also facilitates highly reversible Li metal stripping and plating leading to compact morphology and low pulverization. The LMB of the present invention preferably delivers a specific capacity >230 mAh g⁻¹ and an average Coulombic efficiency >99.65% over 100 cycles. Even under harsh testing conditions, the 4.7 V LMB can retain >88% capacity for 90 cycles, demonstrating significant advances in practical LMBs.

Embodiments of the invention include an electrochemical device (e.g., a battery) that includes a cathode and an electrolyte. The cathode includes at least one transition metal oxide. The electrolyte includes a solvent and lithium bis(fluorosulfonyl)imide (LiFSI) substantially dissolved in the solvent. The solvent includes N, N-dimethyltrifluoromethane-sulfonamide (DMTMSA). The electrolyte may be in the form of a liquid, a solid (e.g., a polymer gel or a ceramic), or a combination of liquid and solid components. During operation of the electrochemical device, the electrolyte substantially suppresses dissolution of the at least one transition metal oxide.

In one embodiment, the DMTMSA and/or LiFSI may be a main component of the electrolyte. In this embodiment, the DMTMSA and/or LiFSI may be present in the electrolyte in a weight percent of about 80% to about 99% of the electrolyte. In another embodiment, the DMTMSA and/or LiFSI may be an additive in the electrolyte. In this embodiment, the DMTMSA and/or LiFSI may be present in the electrolyte in a weight percent of about 1% to about 20% of the electrolyte.

The one or more transition metal oxide in the cathode of the electrochemical device may include lithium cobalt oxide, lithium nickel manganese cobalt oxide, lithium manganese oxide, lithium iron phosphate, or lithium nickel cobalt aluminum oxide. Examples of the transition metal oxide include LiNi_{0.88}MnₓCo_{y}O₂, LiNi_{0.8}Mn_{0.1}Co_{0.1}O₂, LiNi_{0.76}Mn_{0.14}Co_{0.10}O₂, LiNi_{0.6}Mn_{0.2}Co_{0.2}O₂, LiNi_{0.5}Mn_{0.3}Co_{0.2}O₂, LiNi_{0.3}Mn_{0.3}Co_{0.3}O₂, LiNi_{0.4}Mn_{0.4}Co_{0.2}O₂, LiNi_{0.94}Co_{0.06}O₂, Li_{1.252}Mn_{0.557}Ni_{0.123}Co_{0.126}Al_{0.0142}O₂, LiCoO₂.

In one embodiment, the LiFSI may be present in the electrolyte at a concentration of about 0.2 to about 5.0 moles of LiFSI per kilogram of solvent. For example, in this embodiment, the LiFSI may be present in the electrolyte at a concentration of about 1.0 moles of LiFSI per kilogram of solvent. In another embodiment, the LiFSI may be present in the electrolyte at a concentration of about 0.2 to about 5.0 moles of LiFSI per kilogram of DMTMSA. For example, in this embodiment, the LiFSI may be present in the electrolyte at a concentration of about 1.0 moles of LiFSI per kilogram of DMTMSA.

The electrochemical device may include an anode including lithium metal, hard carbon, and/or graphite. The liquid electrolyte may additionally include one or more additives, including fluoroethylene carbonate (FEC); 1,1,2,2-tetrafluoroethyl-2,2,3,3-tetrafluoropropyl ether (TTE); prop-1-ene-1,3-sultone (PST); vinylene carbonate (VC); ethylene carbonate (EC); lithium bis(oxalato)borate (LiBOB); lithium difluoro(oxalato)borate (LiDFOB); and/or tris(trimethylsilyl)phosphite (TMSPi).

Another embodiment of the present technology includes a method of using an electrochemical device such as the electrochemical device described above. The method includes charging the electrochemical device to at least 4.7 V vs. Li/Li⁺, discharging the electrochemical device to about 3.0±0.2 V vs Li/Li⁺, and repeating these charging and discharging steps for at least 100 cycles at room temperature. The electrochemical device has an initial specific discharge capacity of at least about 231 mAh g⁻¹. Over the 100 cycles, the electrochemical device retains an average specific discharge capacity of at least about 88% of the initial specific discharge capacity. The electrochemical device also maintains an average Coulombic efficiency of at least about 99.65% over the 100 cycles. The electrochemical device includes a cathode, a lithium metal anode, and an electrolyte. The charging and discharging steps may be performed at a 0.5 C (1 C=200 mA g) rate.

All combinations of the foregoing concepts and additional concepts discussed in greater detail below (provided such concepts are not mutually inconsistent) are part of the inventive subject matter disclosed herein. In particular, all combinations of claimed subject matter appearing at the end of this disclosure are part of the inventive subject matter disclosed herein. The terminology used herein that also may appear in any disclosure incorporated by reference should be accorded a meaning most consistent with the particular concepts disclosed herein.

### BRIEF DESCRIPTIONS OF THE DRAWINGS

The skilled artisan will understand that the drawings primarily are for illustrative purposes and are not intended to limit the scope of the inventive subject matter described herein. The drawings are not necessarily to scale; in some instances, various aspects of the inventive subject matter disclosed herein may be shown exaggerated or enlarged in the drawings to facilitate an understanding of different features. In the drawings, like reference characters generally refer to like features (e.g., functionally and/or structurally similar elements).

FIG. 1A shows a Li∥NMC811 battery cell with a commercial carbonate electrolyte cycled at high voltage.

FIG. 1B shows a Li∥NMC811 battery cell with a LiFSI/DMTMSA electrolyte cycled at high voltage.

FIG. 1C is a schematic of a battery with a LiFSI/DMTMSA electrolyte.

FIG. 2A shows specific capacity of Li∥NMC811 cells using 1 M LiPF₆/EC-EMC+2% VC or 1 m LiFSI/DMTMSA electrolytes at 0.5 C (0.1 C for the 1^{st} cycle) over 100 cycles.

FIG. 2B shows average voltage of Li∥NMC811 cells using 1 M LiPF₆/EC-EMC+2% VC or 1 m LiFSI/DMTMSA electrolytes at 0.5 C (0.1 C for the 1^{st} cycle) over 100 cycles.

FIG. 2C shows energy efficiency of Li∥NMC811 cells using 1 M LiPF₆/EC-EMC+2% VC or 1 m LiFSI/DMTMSA electrolytes at 0.5 C (0.1 C for the 1^{st} cycle) over 100 cycles.

FIG. 2D shows a voltage profile of a Li∥NMC811 cells using 1 M LiPF₆/EC-EMC+2% VC electrolyte at 0.5 C (0.1 C for the 1^{st} cycle) over 100 cycles.

FIG. 2E shows a voltage profile of a Li∥NMC811 cells using 1 m LiFSI/DMTMSA electrolyte at 0.5 C (0.1 C for the 1^{st} cycle) over 100 cycles.

FIG. 2F shows discharge voltage profiles of GITT measurements of Li∥NMC811 cells using 1 M LiPF₆/EC-EMC+2% VC or 1 m LiFSI/DMTMSA electrolytes after 100 cycles.

FIG. 3A shows leakage currents during 4.7 V constant-voltage floating test of the NMC811 cathodes cycled in different electrolytes for 50 cycle.

FIG. 3B shows transition metal dissolution measured by ICP-MS after 100 cycles in different electrolytes.

FIG. 3C shows in-situ DEMS analysis in half cells to monitor the gas evolution during first charging in 1 M LiPF₆/EC-EMC+2% VC.

FIG. 3D shows in-situ DEMS analysis in half cells to monitor the gas evolution during first charging in 1 m LiFSI/DMTMSA.

FIG. 3E shows XPS analysis of the C 1s peak for an NMC811 cathode cycled in 1 M LiPF₆/EC-EMC+2% VC after 100 cycles.

FIG. 3F shows XPS analysis of the F 1s peak for an NMC811 cathode cycled in 1 M LiPF₆/EC-EMC+2% VC after 100 cycles.

FIG. 3G shows XPS analysis of the C 1s peak for an NMC811 cathode cycled in 1 m LiFSI/DMTMSA after 100 cycles.

FIG. 3H shows XPS analysis of the F 1s peak for an NMC811 cathode cycled in 1 m LiFSI/DMTMSA after 100 cycles.

FIG. 4A is an SEM image of a cross-sectioned NMC811 cathode cycled in 1 M LiPF₆/EC-EMC+2% VC electrolyte.

FIG. 4B is another SEM image of a cross-sectioned NMC811 cathode cycled in 1 M LiPF₆/EC-EMC+2% VC electrolyte.

FIG. 4C is an SEM image of a cross-sectioned NMC811 cathode cycled in 1 m LiFSI/DMTMSA electrolyte.

FIG. 4D is another SEM image of a cross-sectioned NMC811 cathode cycled in 1 m LiFSI/DMTMSA electrolyte.

FIG. 4E shows cross-sections of 3D tomography images at different depths of an NMC811 particle cycled in 1 M LiPF₆/EC-EMC+2% VC electrolyte.

FIG. 4F shows cross-sections of 3D tomography images at different depths of an NMC811 particle cycled in 1 m LiFSI/DMTMSA electrolyte.

FIG. 4G shows HRTEM images of NMC811 particles cycled in 1 m LiFSI/DMTMSA electrolyte.

FIG. 4H shows 2D XANES mapping of NMC811 particles cycled in 1 M LiPF₆/EC-EMC+2% VC for 100 cycles and then charged to 4.7 V vs. Li⁺/Li.

FIG. 4I shows 2D XANES mapping of NMC811 particles cycled in 1 m LiFSI/DMTMSA for 100 cycles and then charged to 4.7 V vs. Li⁺/Li.

FIG. 5A shows proposed stress-corrosion cracking (SCC) for polycrystalline cathodes.

FIG. 5B is the (c/c₀)/(α/α₀) ratio as a function of state of charge (SOC) in an NMC811 cathode.

FIG. 6A shows electrochemical performance of a Li∥Cu coin cells at 0.5 mA cm⁻² and 1 mAh cm⁻² in different electrolytes.

FIG. 6B shows electrochemical performance of a Li∥Li symmetric cells at 0.5 mA cm⁻² and 1.5 mAh cm⁻² in different electrolytes.

FIG. 6C is an SEM image of the cross-section of the lithium metal anode (LMA) collected from a Li∥NMC811 cell after 100 cycles at 0.5 C in 1 M LiPF₆/EC-EMC+2% VC electrolyte.

FIG. 6D is an SEM image of the cross-section of the lithium metal anode (LMA) collected from a Li∥NMC811 cell after 100 cycles at 0.5 C in 1 m LiFSI/DMTMSA electrolyte.

FIG. 6E shows a depth profile of the surface of a LMA after 100 cycles in 1 M LiPF₆/EC-EMC+2% VC electrolyte using XPS.

FIG. 6F shows a depth profile of the surface of a LMA after 100 cycles in 1 m LiFSI/DMTMSA electrolyte using XPS.

FIG. 7A shows electrochemical performance of Li∥NMC811 cells under practical conditions in different electrolytes.

FIG. 7B shows a voltage profile of the cell cycled in 1 M LiPF₆/EC-EMC+2% VC electrolyte in FIG. 7A.

FIG. 7C shows the voltage profile of the cell cycled in 1 m LiFSI/DMTMSA electrolyte in FIG. 7A.

FIG. 8 shows electrochemical stability of different electrolytes over an increasing voltage ramp.

FIG. 9 shows water content in different electrolytes with 3000 ppm water before and after aging. F

FIG. 10 shows the contact angle of 1 M LiPF₆/EC-EMC-2% VC.

FIG. 11 shows the contact angles of conventional electrolyte and 1 m LiFSI/DMTMSA electrolyte.

FIG. 12 shows rate performance of Li∥NMC811 cells using 1 m LiFSI/DMTMSA and 1 M LiPF₆/EC-EMC-2% VC electrolytes.

FIG. 13 shows high-temperature (55° C.) cycling performance of the Li∥NMC811 cells using different electrolytes at 0.5 C. The cells were cycled between 3 V to 4.7 V.

FIG. 14 shows a schematic of the structure of the Li foil after 100 cycles in Li∥NMC811 cells with carbonate and sulfonamide electrolytes.

FIG. 15A shows a Li∥NMC811 pouch cell.

FIG. 15B shows cycling performance of Li∥NMC811 pouch cells with 1 m LiFSI/DMTMSA and 1 M LiPF₆/EC-EMC-2% VC electrolytes.

FIG. 16 shows the solubilities of Ni(TFSI)₂, Co(TFSI)₂ and Mn(TFSI)₂ in 1 m LiFSI/DMTMSA and 1 M LiPF₆/EC-EMC with 2% VC.

FIG. 17A shows specific capacity cycling performance of Li∥LCO cells with different electrolytes.

FIG. 17B shows Coulombic efficiencies cycling performance of Li∥LCO cells with different electrolytes.

FIG. 17C shows operating mid-voltages cycling performance of Li∥LCO cells with different electrolytes.

FIG. 17D shows rate performance of Li∥LCO cells at 4.55 V cut-off voltage with different electrolytes.

FIG. 17E shows voltage profiles of a Li∥LCO cell with sulfonamide electrolyte from the cycling performance in FIG. 17D.

FIG. 17F shows voltage profiles of a Li∥LCO cell with carbonate electrolyte from the cycling performance in FIG. 17D.

FIG. 18A shows electrochemical performance of Li∥graphite half-cells using sulfonamide electrolyte.

FIG. 18B shows the voltage profile of the cell cycled in FIG. 18A.

FIG. 19 shows electrochemical performance of Li—S cells with 1 m LiTFSI in DMTMSA with 16.7% dimethoxyethane (DME) and 1 m LiTFSI in 1,3-dioxolane (DOL) with 16.7% DME.

FIG. 20 shows a scheme for synthesizing DMTMSA.

### DETAILED DESCRIPTION

High-voltage-capacity cathodes and conversion-type anodes (e.g., LMA) are promising high-energy-density batteries, but conventionally batteries that use conversion-type anodes or cycle at a high upper cut-off voltage have poor cycle life due to their increased electrochemical reactivity and unstable SEI. Forming a stable SEI may mitigate the degradation of reactive electrodes and electrolytes.

For the cathode, elevating the upper cut-off voltage can increase the discharge capacity and energy density but conventionally results in poor cycling stability (e.g., a substantial decline in capacity retention and low Coulombic efficiency). For example, the charging voltage in battery cells using LiCoO₂ (LCO) is conventionally limited to values below 4.35 V (vs. Li⁺/Li), yielding a discharge capacity of ˜165 mA h g⁻¹ (Li₁₋ₓCoO₂, x=˜0.6), which is far from the theoretical maximum (274 mA h g⁻¹), because the substantial increase in capacity achieved at higher charging cut-off voltage (4.5 V vs. Li⁺/Li) conventionally comes at the expense of a rapid decay of capacity and efficiency. As another example, an additional 15% to 35% capacity is gained by increasing the upper cut-off voltage of LiNiₓMn_{y}O_{z} NMC cathodes from the conventional upper cut-off voltage of 4.3 V to 4.7 V (vs. Li⁺/Li). Unfortunately, increasing the upper cut-off voltage conventionally induces instabilities in the bulk of the cathode and at the surface of the cathode and thus significantly degrades cycle life. Such degradations become more serious with increasing Ni content and higher cut-off voltages, including for LiNi_{0.8} Co_{0.1}Mn_{0.1}O₂ (NMC811).

Without being bound by any theory, the cathode instabilities associated with increasing the upper cut-off voltage may be due to the high reactivity between conventional electrolyte components and high-valence transition metals in the cathode. The upper cut-off voltage may induce undesirable electrolyte decomposition at the SEI, including solvent oxidation and hydrogen abstraction from solvent molecules, which may contribute to the formation of a high-impedance SEI. The high-impedance SEI may promote further degradation of the cathode and undesirable changes in cathode phase. Forming a stable SEI at the cathode may mitigate degradation and promote longer cycling lifetimes.

On the anode side, using an LMA, cycling performance depends on the reversibility of the conversion reaction. High reversibility reduces the usage of excess lithium metal and electrolyte relative to the cathode. However, significant challenges associated with the instability of LMA conventionally hinder the practical application of lithium-metal batteries (LMBs). The unstable SEI between reactive Li and electrolyte leads to severe side reactions, detrimental Li⁺ deposition morphology (e.g., mossy Li), and thus poor LMA reversibility.

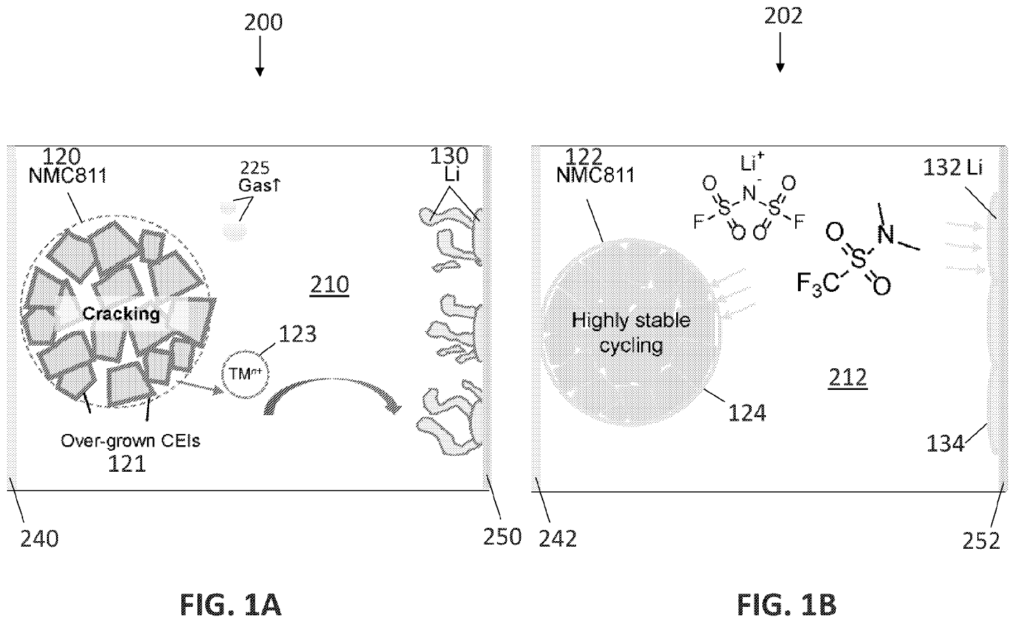

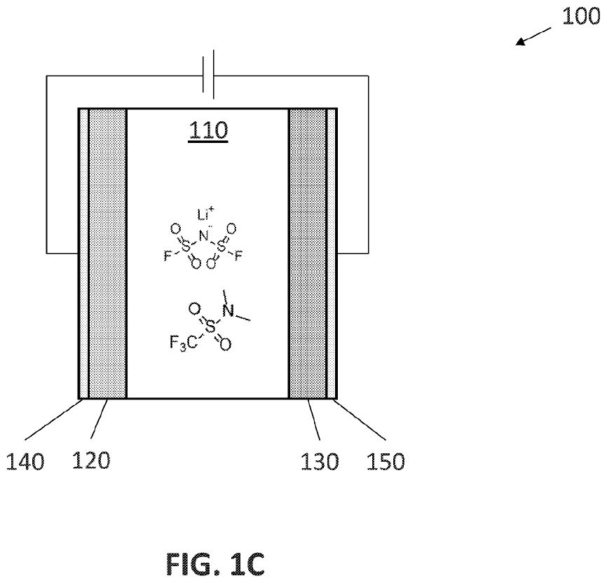

FIGS. 1A and 1B compare degradation in cells 200, 202 cycled with high (e.g., 4.7 V) upper cut-off voltage using a conventional carbonate-based electrolyte 210 and LiFSI/DMTMSA electrolyte 212, respectively. The electrolyte influences the cycling morphology and reversibility of the electrodes. In the cell 200, using a carbonate-based electrolyte 210, several degradation mechanisms degrade the cathode 120 and the anode 130. In the cathode 120, these degradation mechanisms include bulk and surface phase transformations, cracking of the cathode particles (e.g., cracking of secondary phase cathode particles), over-growth of cathode electrolyte interphases (CEIs) 121, gas evolution 225, and transition metal (TM) dissolution 123. Dissolved TMs may waft to the anode side where they can be reduced and accumulated, contributing to the destruction of the anode's SEI, consumption of active Li from the LMA 130 and increased cell impedance. The LMA 130 can also degrade via depletion of the limited cyclable Li inventory by side reactions with the carbonate-based electrolyte 210. The LMA can become kinetically unreachable due to electronic/ionic isolation due to byproducts of these side reactions. These degradation processes may also increase resistance between the cathode 120 and the current collector 240, and between the anode 130 and the current collector 250. The electrolyte itself can also be rapidly depleted or contaminated by side reactions, and loss of percolation can happen due to wetting of large surface-area, thick Li deposits.

In contrast, the LiFSI/DMTMSA electrolyte 212 in cell 202 facilitates highly reversible cycling of the LMA 132 by favoring compact Li metal deposition morphologies, decreased pulverization, and a stable SEI 134 on the LMA 132. The electrolyte 212 also facilitates stable cycling of the cathode 122 using high (e.g., 4.7 V) upper cut-off voltage with a high specific capacity and Coulombic efficiency (CE) (e.g., for NMC, specific capacity >230 mAh g⁻¹ and an average CE>99.65% over 100 cycles), by suppressing cathode particle intergranular stress-corrosion cracking, partially due to decreased transition-metal ion solubility in the sulfonamide-based electrolyte. In this way, the electrolyte 212 forms a stable SEI 124 at the cathode surface. With degradation mechanisms suppressed by the electrolyte 212, the cathode maintains electrical contact with the current collector 242 and the anode maintains electrical contact with the current collector 252.

FIG. 1C shows a battery cell 100 using a highly compatible electrolyte 110. The electrolyte 110 includes a liquid aprotic N, N-dimethyltrifluoromethane-sulfonamide (DMTMSA) solvent, which belongs to the sulfonamide family, and a regular concentration (about 0.2 m to about 1.5 m, including 0.2 m, 0.4 m, 0.5 m, 0.6 m, 0.8 m, 1 m, 1.2 m, or 1.5 m, preferably about 1 m, where m stands for molality) of LiFSI (referred as LiFSI/DMTMSA hereafter). The electrolyte 110 facilitates highly reversible cycling at voltages as high as 4.7 V (vs. Li/Li⁺) by promoting the formation of a stable SEI at the cathode and at the anode. The battery includes a cathode 120, an anode 150, and current collectors 140 and 150 disposed on a surface of the cathode 120 and the anode 150, respectively.

The cathode active material in the cathode 120 is a lithium (Li) transition metal (M) oxide. In one embodiment, the cathode core material has a layered crystal structure and a chemical formula LiMO₂. In this embodiment, M is preferably one or more 3d transition metals. More preferably, M includes at least one of cobalt (Co), nickel (Ni), and/or manganese (Mn) (e.g., LCO, LiₓNi_{1-y-z}Mn_{y}Co_{z}O₂). The layered crystal structure may include other metal elements, including aluminum (Al) (e.g., LiNiₓCo_{y}Al_{z}O₂). Any of these examples of layered cathode core materials may additionally be Li-rich (e.g., Li_{1.17}Mn_{0.50}Ni_{0.24}Co_{0.09}O₂). In another embodiment, the cathode core material has a spinet crystal structure and a chemical formula LiMO₄. In this embodiment, M preferably includes one or more 3d transition metals. More preferably, M includes Mn. The spinel cathode core material may be cubic (e.g., LiₓMn₂O₄) or high voltage (e.g., LiₓMn_{1.5}Ni_{0.5}O₄). In another embodiment, the cathode core material has a disordered rocksalt crystal structure. In this embodiment, the cathode core material has a crystalline rocksalt structure but with a disordered arrangement of Li and M on the cation lattice. The M is preferably one or more 3d or 4d transition metals. More preferably, M includes at least one of Ni, Co, Mn, vanadium (V), iron (Fe), chromium (Cr), molybdenum (Mo), and/or titanium (Ti) (e.g., Li_{1.25}Mn_{0.25}Ti_{0.5}O_{2.0}). The disordered rocksalt cathode core material may include other metal elements, including zirconium (Zr), niobium (Nb), and/or molybdenum (Mo). Some of the oxygen content in the disordered rocksalt cathode may be substituted with fluorine (e.g., Li_{1.25}Mn_{0.45}Ti_{0.3}O_{1.8}F_{0.2}). Examples of the transition metal oxide include LiNi_{0.88}MnₓCo_{y}O₂, LiNi_{0.8}Mn_{0.1}Co_{0.1}O₂, LiNi_{0.76}Mn_{0.14}Co_{0.10}O₂, LiNi_{0.6}Mn_{0.2}Co_{0.2}O₂, LiNi_{0.5}Mn_{0.3}Co_{0.2}O₂, LiNi_{0.3}Mn_{0.3}Co_{0.3}O₂, LiNi_{0.4}Mn_{0.4}Co_{0.2}O₂, LiNi_{0.94}Co_{0.06}O₂, Li_{1.252}Mn_{0.557}Ni_{0.123}Co_{0.126}Al_{0.0142}O₂, LiCoO₂. Alternatively, the cathode active material in the cathode 120 includes sulfur. The cathode 120 may have a low loading of active material (e.g., <3.5 mAh cm⁻²) or a high loading of active material (e.g., about 3.5 mAh cm⁻² to about 10 mAh cm⁻², including 3.5 mAh cm⁻², 4 mAh cm⁻², 6 mAh cm⁻², 8 mAh cm⁻², or 10 mAh cm⁻²).

The active material in the anode 130 may include lithium metal, an intercalation-type material, a conversion-type material; and/or an alloying-type material. In intercalation-type anodes, Li⁺ reversibly intercalates as a guest ion in the crystal structure of intercalation-type material with modest volume expansion. Examples of intercalation-type anodes include graphite, hard carbon, lithium titanate, and graphite intercalation compounds. In conversion-type anodes, Li⁺ is stored through reversible redox reactions. Examples of conversion-type anodes include, transition metal oxides, transition metal sulfides, and/or transition metal phosphides. In alloying-type anodes, Li⁺ is stored through reversible alloying. Examples of alloying-type anodes include silicon. The active material in the anode 150 may include more than one type of material (e.g., a mixture of two or three different types).

The cell 100 may include a separator disposed between the cathode 120 and the anode 130. The separator may be any material that facilitates the movement of ions through the cell (e.g., polymer or glass fiber).

The electrolyte 110 provides a conductive pathway for the movement of Li⁺ ions between the electrodes. The LiFSI is a lithium salt that is substantially dissolved in the electrolyte. The LiFSI is present in a concentration of about 0.2 to about 5.0 moles of LiFSI per kilogram (kg) of solvent (e.g., 0.2, 0.5, 1.0, 2.0, 3.0, 4.0, or 5.0 moles per kg). The cell 100 may be assembled with high electrolyte (e.g., with an electrolyte to capacity, E/C ratio, of about >10 g/Ah) or lean electrolyte quantities (e.g., with an E/C ratio of about 1 g/Ah to about 10 g/Ah, preferably 2 g/Ah to 5 g/Ah).

In addition to LiFSI/DMTMSA, the electrolyte 110 may include other components. For example, the electrolyte 110 may include one or more other organic liquids (e.g., ethylene carbonate, dimethyl carbonate, and/or room-temperature ionic liquids) or polymer gels (e.g., poly(oxyethylene)). The electrolyte 110 may also include one or more other lithium salts (e.g., LiPF₆). The concentration of the LiFSI/DMTMSA solution in the electrolyte 110 may be 1% to about 99% by weight. The weight percentage of LiFSI in LiFSI/DMTMSA is about 15% to about 20%, so the total concentration of LiFSI in the electrolyte 110 is the result of multiplying about 15% to about 20% by the weight percentage of LiFSI/DMTMSA in the electrolyte 110. For example, in an embodiment where the electrolyte 110 includes LiFSI/DMTMSA in a weight percent of about 80% and other components in a weight percent of about 20%, the weight percentage of LiFSI is about 80%>20%, or 16%.

In an embodiment, the LiFSI/DMTMSA may be the main component of the electrolyte, with a concentration of about 80% to 99% by weight (e.g., 80%, 85%, 90%, 95%, or 98%). In another embodiment, the LiFSI/DMTMSA may be an additive in the electrolyte, with a concentration of about 0.1% to about 20% (e.g., 1%, 2%, 5%, 10%, or 20%).

The electrolyte 110 may additionally include one or more other additives, including fluoroethylene carbonate (FEC); 1,1,2,2-tetrafluoroethyl-2,2,3,3-tetrafluoropropyl ether (TTE); prop-1-ene-1,3-sultone (PST); vinylene carbonate (VC); ethylene carbonate (EC); lithium bis(oxalato)borate (LiBOB); lithium difluoro(oxalato)borate (LiDFOB); and/or tris(trimethylsilyl)phosphite (TMSPi). The additive may be present in a concentration of about 0.1% to about 30% by weight (e.g., 1%, 2%, 5%, 10%, 16%, 20%, or 30%).

In addition to the electrolyte 110, an additional electrolyte layer may be disposed between electrodes. The additional electrolyte layer may be a solid electrolyte. The solid electrolyte may be a solid gel polymer electrolyte (e.g., poly(oxyethylene, polyvinylpyrrolidone, and/or polyacrylamide), or a ceramic electrolyte (e.g., LGPS, LiPS, LLZO, LISICON, and/or LLTO). The solid electrolyte layer may be disposed between the anode 130 and the electrolyte 110. The solid electrolyte layer may minimize usage of the liquid electrolyte and improve battery safety.

Battery cells with the LiFSI/DMTMSA electrolyte may be charged to a high voltage and still maintain long cycling stability (e.g., high capacity retention and CE). The battery cell may be charged to at least 4.45 V. Preferably, the battery cell may be charged to at least 4.50 V. More preferably, the battery cell may be charged to at least 4.55 V. Specifically, the battery cell may be charged to about 4.62 V. The battery cell may be discharged to about 3.0 V±0.2 V, giving a voltage window as wide as about 2.98 V to about 4.70 V. The charging and discharging rates may be about 10 mA/g to about 500 mA/g. For example, the charging and discharging rates may be at least about 10 mA/g. Preferably, the charging and discharging rates may be at least about 100 mA/g. More preferably, the charging and discharging rates may be at least about 150 mA/g. Specifically, the charging and discharging rates may be about 100 mA/g. The battery may cycle stably for at least 100 cycles. Preferable, the battery may cycle stably for at least 200 cycles. More preferably, the battery may cycle stably for at least 300 cycles. Specifically, the battery may cycle stably for at least about 500 cycles. Here, stable cycling is defined as a capacity retention (the ratio of the discharge capacity at cycle n to the initial discharge capacity) of at least about 80%.

The cell 100 may preferably be operated under practical conditions. Practical conditions include a high-loading cathode (e.g., >3.5 mAh cm⁻²), low negative to positive (N/P) ratio, and lean electrolyte (e.g., for electrolyte to capacity, E/C ratio is about 2-5 g Ah⁻¹). These practical conditions are harsh, and conventionally make it extremely difficult to maintain a satisfactory cycle life (e.g., about 200 to about 500 cycles in an academic setting and about 2,000 to about 3,000 in an industrial setting). In contrast, the LiFSI/DMTMSA in the electrolyte 110 facilitates stable cycling under these practical conditions.

LiFSI/DMTMSA Facilitates Stable Cycling of LiNi_{0.8}Mn_{0.1}Co_{0.1}O₂ (NMC811) with an Upper Cutoff Voltage of 4.7 V

The 1 m LiFSI/DMTMSA electrolyte shows good Li⁺ conductivity (Table 1), good oxidation stability, compatibilities with high-voltage cathodes and the LMA, as well as other benefits including good resistance to residual water and wettability with separator (FIG. 11D and Table 2). The cycling stability of the NMC811 cathode with an upper cutoff of 4.7 V vs. Li⁺/Li was tested with the 1 m LiFSI/DMTMSA electrolyte. The NMC811 cathodes had an areal loading of active materials of about 7.5 mg cm⁻² unless otherwise specified. The NMC811 powder was coated with LiBxOy.

DMTMSA was synthesized in accordance with the procedure described in Feng S., et al. Molecular design of stable sulfamide- and sulfonamide-based electrolytes for aprotic Li—O₂ batteries. Chem 5, 2630-2641 (2019), which is incorporated herein by reference in its entirety. Possible residual water was removed from the salt and as-received solvent by heat-treatment under vacuum and molecular sieves before use, respectively. Molality (“m,” mol-salt in kg-solvent, mol kg⁻¹) and molarity (“M”, mol-salt in L-solution, mol L⁻¹) are used to denote the salt concentration in electrolytes. No other ingredient was employed in the sulfonamide-based electrolyte as additive unless otherwise specified.

A commercial carbonate electrolyte, 1 M lithium hexafluorophosphate in ethylene carbonate and ethyl methyl carbonate with a 3:7 weight ratio and with 2% by weight vinylene carbonate (abbreviated as 1 M LiPF₆/EC-EMC+2% VC hereafter, where M stands for molarity), was used as the conventional electrolyte for comparison.

TABLE 1
Li⁺ conductivity in different electrolytes

| | Li⁺ conductivity (mS cm⁻¹) |
|---|---|
| 1M LiPF₆/EC-EMC-2% VC | 9.91 |
| 1M LiPF₆/EC-EMC | 9.72 |
| 1 m LiFSI/DMTMSA | 1.37 |
| 0.5 m LiFSI/DMTMSA | 1.09 |
| 1.5 m LiFSI/DMTMSA | 1.26 |

TABLE 2
Basic properties of carbonate and sulfonamide-based electrolytes

| | Li⁺ | Li⁺ | | Water | | Contact |
|---|---|---|---|---|---|---|
| | conductivity | transference | Viscosity | content | Density | angle |
| | (mS cm⁻¹) | number | (mPa s) | (ppm) | (g cm⁻³) | (°) |
| 1M LiPF₆/ | 9.91 | 0.51 | 3.8 | 45.0 | 1.2 | 47.0 |
| EC-EMC- | | | | | | |
| 2% VC | | | | | | |
| 1 m LiFSI/ | 1.37 | 0.62 | 4.4 | 42.5 | 1.4 | 23.4 |
| DMTMSA | | | | | | |

CR2032 coin cells were prepared using NMC811 as cathode, Celgard 2325 (PP/PE/PP) as separator, and Li metal anode in the glove box. For cathodes with high areal loading, NMC811, Super C65 and polyvinylidene fluoride (PVDF) binder in a weight ratio of 94:3:3 were mixed with N-methyl-2-pyrrolidone (NMP) to form a uniform slurry which was coated onto Al foil using a doctor blade. The thickness was ˜96 μm for the high-loading NMC811 cathode and ˜52 μm for the low-loading NMC811 cathode, both including 15 μm-thick Al foil. The porosity was ˜33% for the high-loading NMC811 cathode and ˜36% for the low-loading NMC811 cathode. Then the coated electrodes were dried at 120° C. overnight. Finally, the electrodes were rolled and punched.

Li metal foils with 350 μm and 60 μm (on Cu) were used. The Li anode paired with high loading NMC811 cathodes in coin cell was fabricated by electrochemical deposition on Cu foil without pre-treatment. Electrolyte amounts in coin cells were carefully controlled by pipette. Landt CT 2001A and BTS9000 Neware cyclers were used to perform galvanostatic cycling at different C rates (1 C is 200 mA g⁻¹).

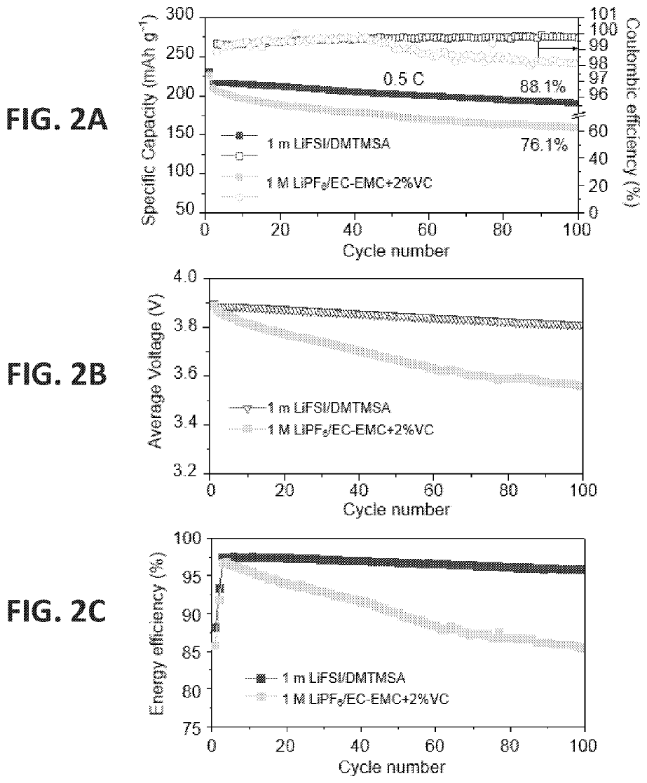

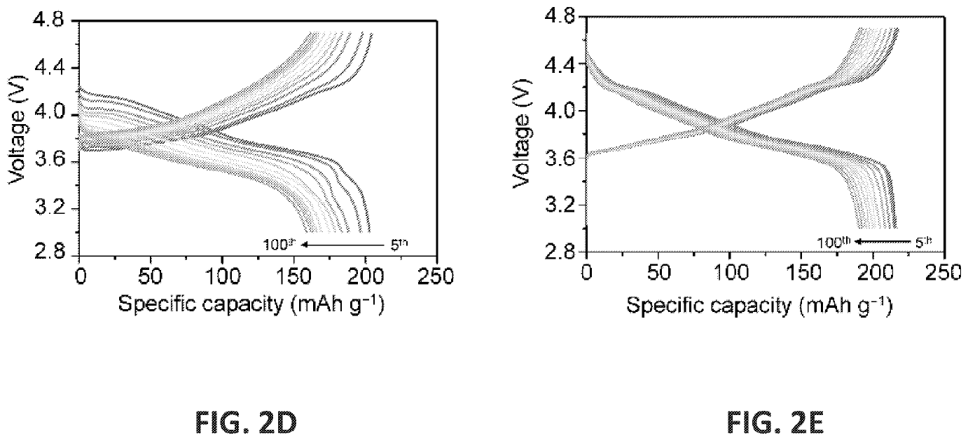

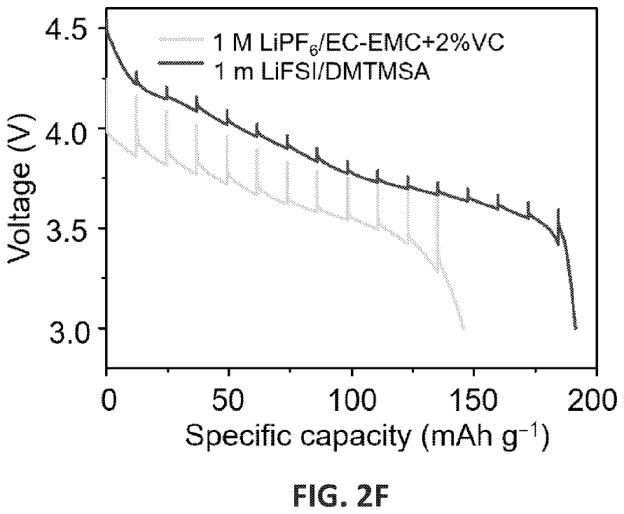

FIGS. 2A-2E show electrochemical performance of Li∥NMC811 cells using different electrolytes, either 1 m LiFSI/DMTMSA or 1 M LiPF₆/EC-EMC-2% VC. FIG. 2A shows specific capacity and coulombic efficiency (CE) of the Li∥NMC811 cells with either 1 m LiFSI/DMTMSA or 1 M LiPF₆/EC-EMC-2% VC over 100 electrochemical cycles. The cells were cycled with an upper cutoff voltage of 4.7 V vs. Li⁺/Li and a lower cutoff voltage of 3.0 V vs. Li⁺/Li. The cells were cycled at a rate of 0.5 C, except for the first cycle, which was cycled at 0.1 C. The cell with the conventional electrolyte showed 76.1% capacity retention after 100 cycles and low CE of ˜98% at cycle 100. In contrast, the cell with the 1 m LiFSI/DMTMSA electrolyte delivered a high discharge capacity of 231 mAh g⁻¹, superior capacity retention of 88.1% after 100 cycles at 0.5 C, and a high average CE of >99.65%. The cell with the 1 m LiFSI/DMTMSA electrolyte was cycled using stringent conditions (thin Li foil ˜60 μm and limited electrolyte ˜20 μL), for which the cell with the conventional electrolyte failed rapidly. The cell with the 1 M LiPF₆/EC-EMC-2% VC used excessive conditions (a thick, about 350 μm Li metal and abundant, about 80 μL electrolyte).

FIG. 2B shows average voltage and FIG. 2C shows energy efficiency measured in the two cells during the cycling in FIG. 2A. Despite of the harsher testing conditions, the 1 m LiFSI/DMTMSA electrolyte showed less voltage decay, higher energy efficiency, and higher first-cycle CE than the cell with the conventional carbonate-based electrolyte in excess conditions. Under stringent conditions, the cell with the conventional carbonate-based electrolyte had very poor performance with a sudden capacity drop after about 40 cycles, likely because of compatibility issues between the electrolyte and the electrodes.

The cell with the LiFSI/DMTMSA electrolyte also had more stable voltage profiles compared to the reference electrolyte, as shown in FIGS. 2D and 2E. The Li∥NMC811 with the 1 m LiFSI/DMTMSA electrolyte had a high average energy efficiency of about 97% over 100 cycles using a high upper cutoff voltage of 4.7 V vs. Li⁺/Li, surpassing the conventional target energy efficiency of 90-95% for next-generation high-voltage NMC.

FIG. 2F shows discharge voltage profiles of galvanostatic intermittent titration technique (GITT) measurements on the cells shown in FIG. 2A after the 1^{st} and 100^{th} cycles. GITT measurements may provide insights into the degradation mechanisms present in the cells during cycling. GITT was performed on cycled coin cells within a voltage range of 3.0 V˜4.7 V with current pulse intervals at ˜0.5 C for 8 minutes, followed by 60-minute rests. The overpotentials of the cathode cycled in the 1 m LiFSI/DMTMSA electrolyte were much smaller than those of the cell cycled with the conventional electrolyte. Moreover, the open-circuit voltage profiles barely changed for all the samples, which suggests the degradation of the NMC811 when cycled with an upper cut-off voltage of 4.7 V vs. Li⁺/Li may have a kinetic origin, suggesting the presence of side reactions at the cathode surface (forming high-impedance surface phases and CEIs) and inside the secondary particles.

To evaluate the side reactions between the NMC811 cathode and the LiFSI/DMTMSA electrolyte, accelerated degradation tests were conducted by continuously exposing the cathode to high voltage conditions at 4.7 V vs. Li⁺/Li.

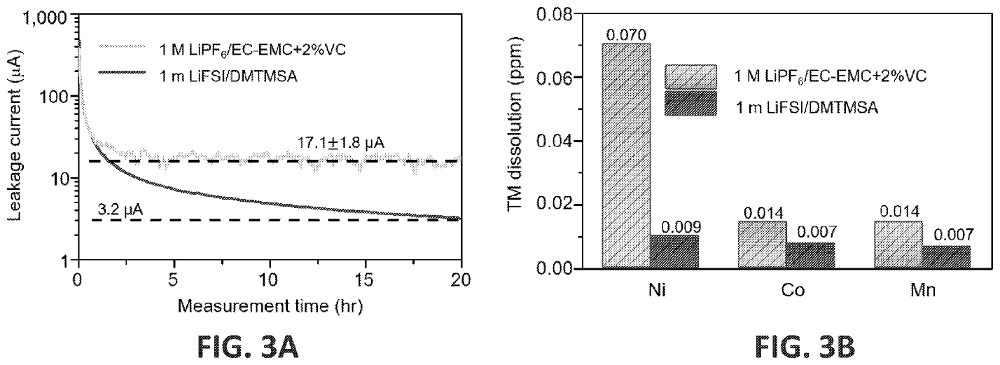

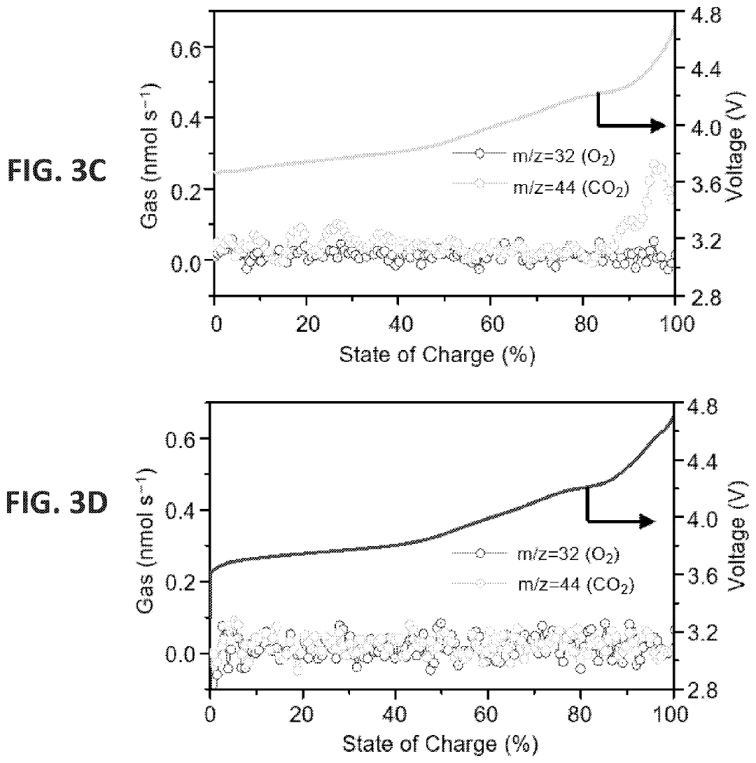

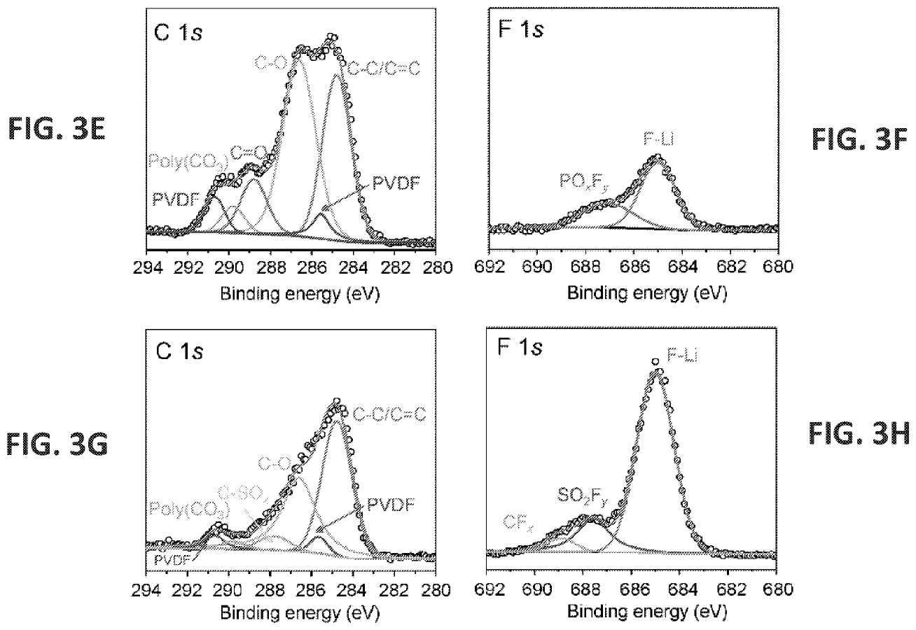

FIGS. 3A-3H show characterizations of cathode-electrolyte side reactions and cathode-electrolyte interfaces (CEIs) at a cut-off voltage of 4.7 V vs. Li⁺/Li. FIG. 3A shows leakage currents during 4.7 V vs. Li⁺/Li constant-voltage floating tests of the NMC811 cathodes cycled in different electrolytes for 50 cycle. The leakage current characterized the side reaction rates and suggested that more side reactions happened for the cell cycled in the conventional electrolyte than that cycled in the LiFSI/DMTMSA electrolyte. Compared to the conventional electrolyte with a quasi-steady-state leakage current of ˜17 μA after an initial decay at about 5 hours, the leakage current for the LiFSI/DMTMSA electrolyte monotonically decreased, reaching a lower value of 3.2 μA at the end of a 20-hour hold at 4.7 V vs. Li⁺/Li. This observation indicated the LiFSI/DMTMSA electrolyte facilitated a diminishing side reaction rate and passivated the cathode surface.

The electrochemical floating test was performed in coin cells with NMC811 and Li metal as cathode and anode in different electrolytes. The cells were first charged to 4.7 V at 0.1 C and then maintained for 20 hours with the current monitored by the Neware cycler.

FIG. 3B shows transition metal (TM) dissolution measured by inductively coupled plasma mass spectrometry (ICP-MS) after 100 cycles in different electrolytes. Compared to the conventional electrolyte, the LiFSI/DMTMSA electrolyte had lower concentrations of dissolved transition metals. In particular, the LiFSI/DMTMSA electrolyte had a much lower concentration of nickel than the conventional electrolyte. After 100 cycles, there was an 8-fold decrease in dissolved Ni and a 4-fold decrease in total dissolved transition metals in the LiFSI/DMTMSA electrolyte as compared to the conventional electrolyte. These results indicate that transition metals are less soluble in the LiFSI/DMTMSA electrolyte, the LiFSI/DMTMSA electrolyte may suppress transition metal dissolution, and this suppression may facilitate more stable cycling.

FIGS. 3C and 3D show in-situ differential electrochemical mass spectrometry (DEMS) analysis in half cells during first charging in 1 M LiPF₆/EC-EMC+2% VC and 1 m LiFSI/DMTMSA electrolytes, respectively. DEMS analysis monitors the gas evolution during the cycle. The half-cell with 1 m LiFSI/DMTMSA electrolyte had less CO₂ evolution in the voltage range of about 4.3 V to about 4.7 V vs Li⁺/Li as compared to the half cell with conventional electrolyte. These results indicate that side reactions present at high voltages in conventional electrolyte are suppressed in the cell using 1 m LiFSI/DMTMSA electrolyte.

FIGS. 3E-3H show XPS analysis for the NMC811 cathodes cycled in 1 M LiPF₆/EC-EMC+2% VC (FIGS. 3E and 3F) and 1 m LiFSI/DMTMSA (FIGS. 3G and 3H) electrolytes after 100 cycles. XPS analysis was used to characterize the CEIs formed over 100 cycles. Compared to the cathode cycled in the conventional electrolyte, the one cycled in the LiFSI/DMTMSA electrolyte had weaker C 1s signal (FIG. 3G, especially the peaks that can be attributed to C—O, C═O and poly(CO₃)), stronger F is signal (FIG. 3H; especially the peak that can attributed to F—Li). The results indicate that the CEIs derived from the LiFSI/DMTMSA electrolyte may include more LiF-like inorganic components and fewer organic components. LiF-like inorganic components may stabilize the CEI.

Intergranular cracking between connected primary particles in a secondary cathode particle may contribute to degradation of Ni-rich cathodes, especially with higher cut-off voltages and prolonged cycling. Intergranular cracking may result in the loss of electrical contacts between primary cathode particles. Intergranular cracking may also create an increased electrochemical surface area, which means more liquid electrolyte is used for wetting, more side reactions, and more electrolyte consumption. In industrial batteries, the liquid electrolyte is present in an amount of about 2 to about 5 g Ah⁻¹. This amount is used to wet the cathode, anode, and separator, often making it the scarcest component. Intergranular cracking may be severe for the NMC811 cathodes cycled in the conventional electrolyte, as evidenced by the GITT analysis. The GITT analysis of the cathode cycled in conventional electrolyte identified large overpotential growth in the form of ohmic loss that is closely related to electron transport at the electrode level.

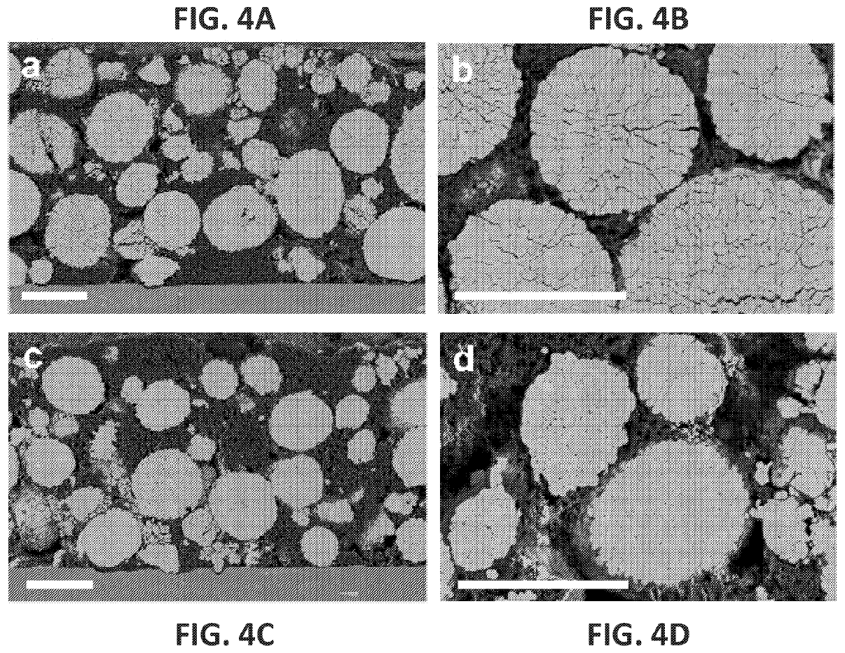

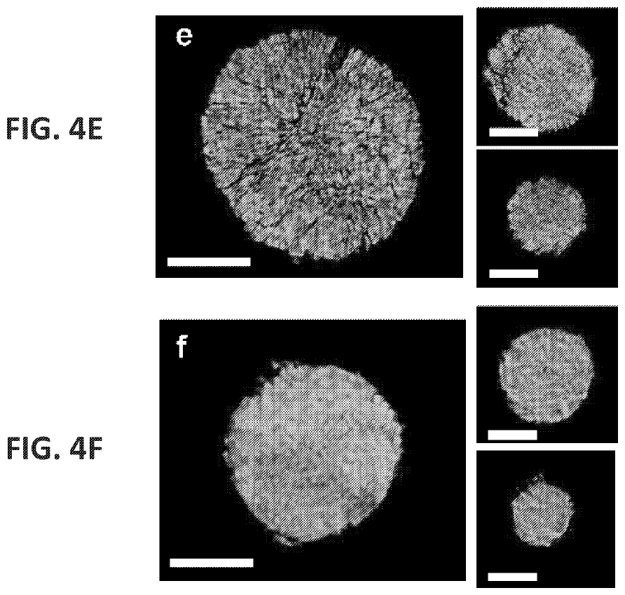

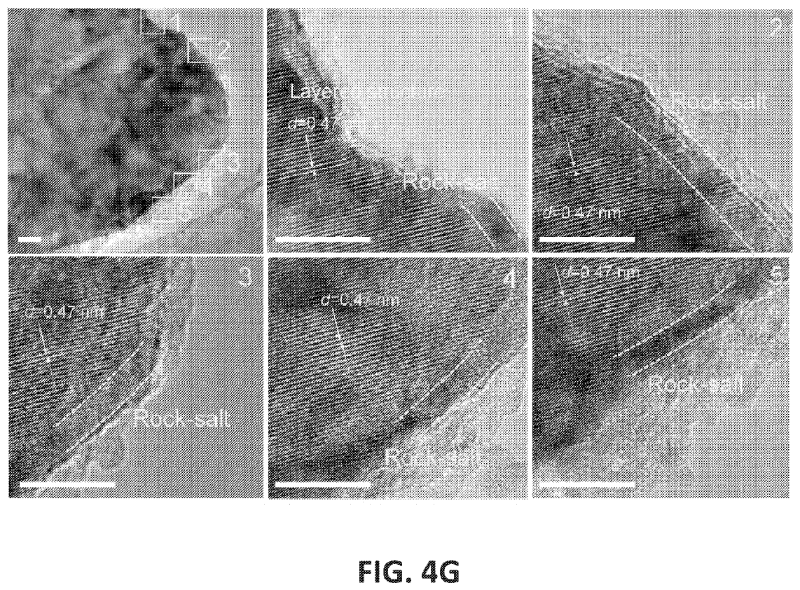

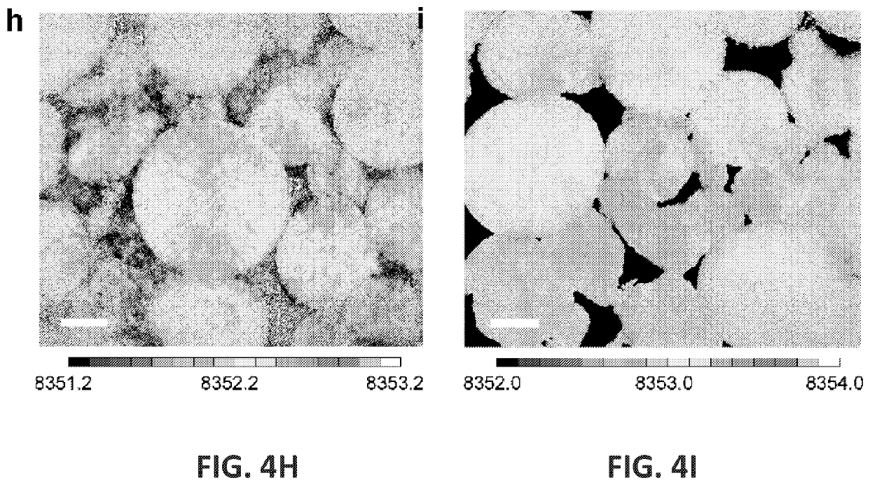

FIGS. 4A-4G show structural characterizations of the cycled NMC811 cathodes with either the LiFSI/DMTMSA or the conventional electrolyte. To characterize microstructural degradation, cathodes after 100 cycles were cross-sectioned and inspected under scanning electron microscopy (SEM). The cathodes for SEM were collected by dissembling the cells in a glove box under inert atmosphere and then washed with DMC 3 times.

FIGS. 4A and 4B show extensive cracking in the cathode cycled with the conventional electrolyte. In comparison, FIGS. 4C and 4D show that cracking was suppressed or delayed with the LiFSI/DMTMSA electrolyte. FIGS. 4E and 4F show the morphology of cycled NMC811 secondary particles examined by 3-dimensional tomography of the full-field X-ray imaging (FXI) at the National Synchrotron Light Source II (Brookhaven National Laboratory). FIG. 4E shows the re-constructed images of the cracking behavior with the conventional electrolyte, showing severe cracking along radial direction. FIG. 4F shows the re-constructed images of the cracking behavior with the LiFSI/DMTMSA electrolyte, showing intact primary particles.

FIG. 4G shows high-resolution transmission electron microscopy (HRTEM) images of NMC811 particles cycled in 1 m LiFSI/DMTMSA electrolyte. The NMC cathode performance can degrade due to surface phase transitions from conductive layered to resistive rock-salt NiO-like crystal structures. HRTEM images showed the transformed rock-salt layer is thin (3-4 nm) and uniform (shown by panels 1-5 of FIG. 4gG taken from five local regions) over the surface of the cathode cycled in the 1 m LiFSI/DMTMSA electrolyte, while the one cycled with the conventional electrolyte had a very thick rock-salt layer of >20 nm. This finding agrees well with the improved electrochemical performance by the electrolyte and the suppressed side reactions discussed above.

FIGS. 4H and 4I show 2D X-ray absorption near edge structure (XANES) mapping of NMC811 particles cycled in 1 M LiPF₆/EC-EMC+2% VC and 1 m LiFSI/DMTMSA electrolytes, respectively, for 100 cycles and then charged to 4.7 V vs. Li⁺/Li. The redox chemistry in the bulk of the active cathode particles may be affected by the loss of electrical contacts and phase transitions at exposed fresh surfaces due to cracking. Using the XANES mode of the FXI, Ni oxidation states were mapped in the cycled cathodes at the fully charged state (i.e., 4.7 V vs. Li⁺/Li). The XANES images indicate that Ni has higher and more narrowly distributed oxidation states in the cathode cycled in the LiFSI/DMTMSA electrolyte than in the conventional electrolyte. The results indicate favorable bulk cathode electrochemistry with more uniform redox states in the cell cycled in the LiFSI/DMTMSA.

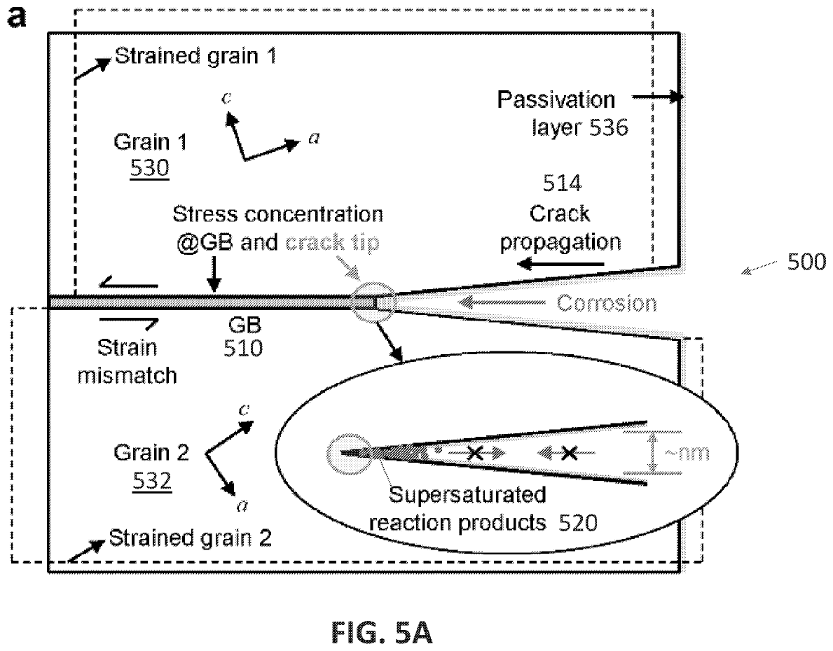

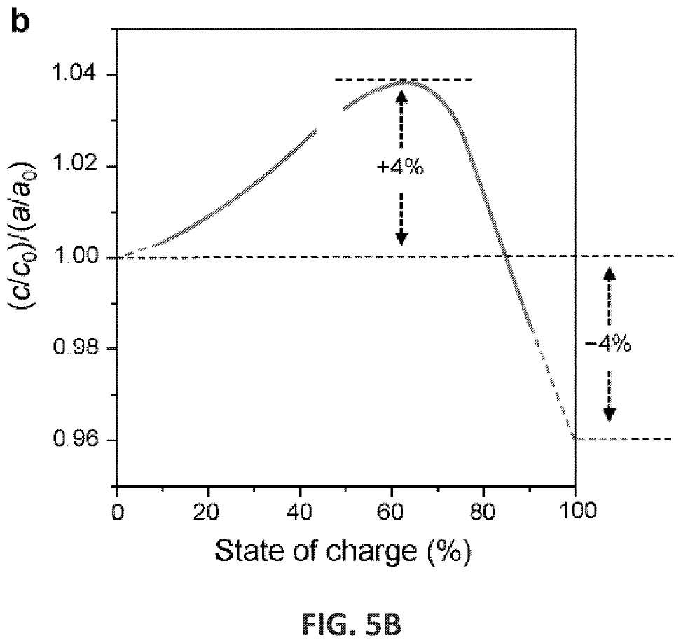

FIG. 5A shows a possible stress-corrosion cracking (SCC) degradation mechanism for polycrystalline cathodes. Besides mechanical stress, chemical interactions between the cathode surface and the electrolyte may play a role in intergranular cracking 500. Conventionally, intergranular cracking may be attributed to mechanical stress created by anisotropic lattice expansion and shrinkage and heterogeneous charge/discharge kinetics during electrochemical cycling. For example, a strain mismatch between a first grain 530 and a second grain 532 may promote cracking at the grain boundary (GB) 510. However, intergranular cracking may be mitigated or slowed by the LiFSI/DMTMSA electrolyte, as described above. These results indicate that intergranular cracking in the cathode may be more than a stress-driven event and the electrolyte may mitigate or slow microstructure degradation of the deep-cycled cathode. SCC may be largely suppressed by the LiFSI/DMTMSA electrolyte because the electrolyte is less reactive with and corrosive to the cathode surface, where it forms a stable passivation layer 536. Also, the supersaturated side reaction products 520 from the reaction between the LiFSI/DMTMSA electrolyte and the cathode surface concentrate in the nano-channel near the crack tip of crack propagation 514 to suppress further cracking.

FIG. 5B shows the (c/c₀)/(α/α₀) ratio as a function of state of charge (SOC) in NMC811 cathode. The dash lines are extrapolated data to fully-charged/discharged states. The proposed SCC mechanism in FIG. 5A is consistent with the observation that single-crystalline NMC and LiCoO₂ cathode materials do not crack as easily as their polycrystalline forms, indicating that uniform eigenstrain (i.e., stress-free strain induced by lithiation/delithiation chemical expansion) does not crack the brittle ceramic particles despite its relatively large magnitude. It is the large linear-strain mismatch at grain boundaries of a polycrystalline cathode material, given the ±4% change in anisotropic ratio (c/c₀)/(α/α₀) during charge/discharge, which leads to either large elastic stress (˜6 GPa with ˜140 GPa Young's modulus) or slippage (inelastic grain boundary sliding).

Improved Li Metal Reversibility

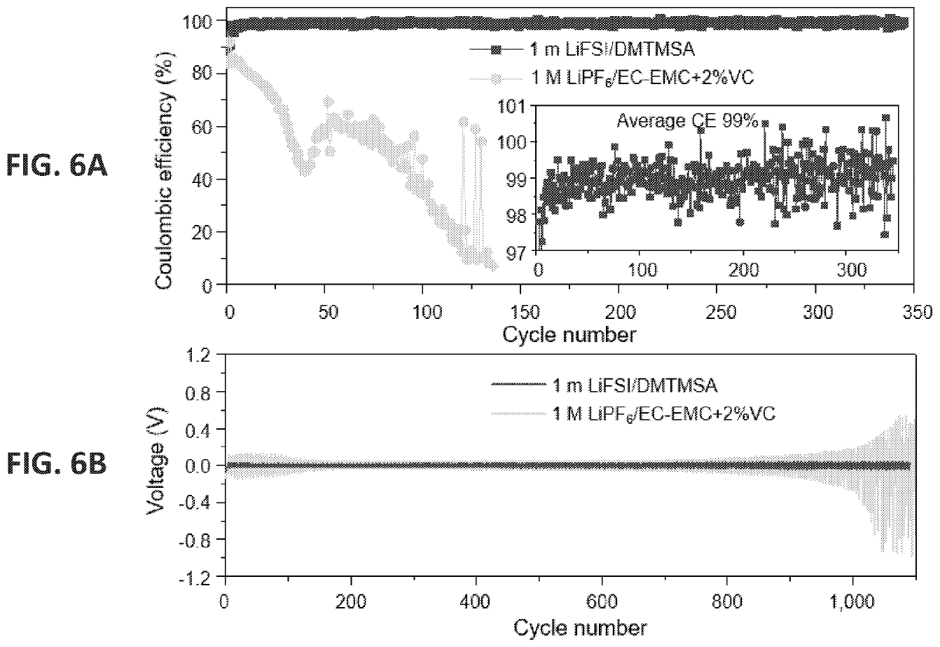

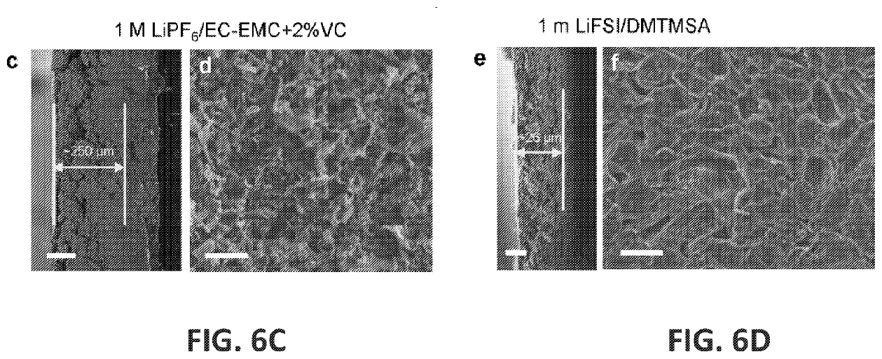

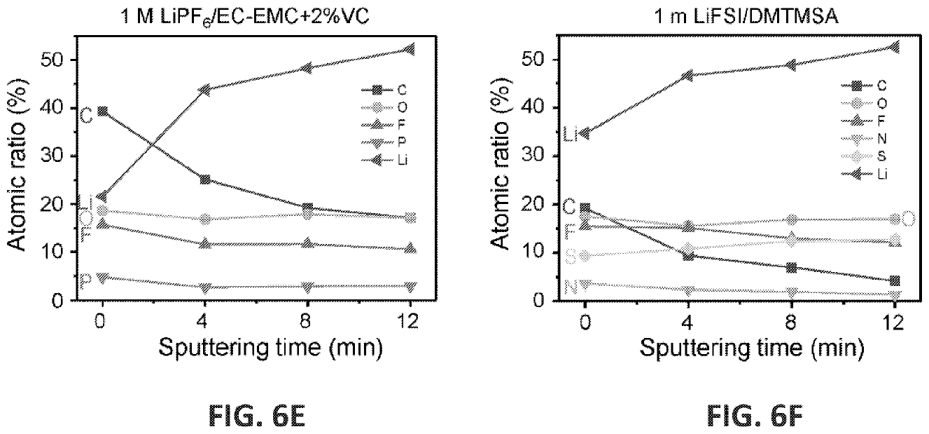

FIGS. 6A-6F show electrochemical performance and characterizations of the LMA in conventional or 1 m LiFSI/DMTMSA electrolyte. The cycling stability of LMBs also relies on the compatibility between the electrolyte and the LMA. FIG. 6A shows Li plating/stripping CEs evaluated in Li∥Cu coin cells using conventional or 1 m LiFSI/DMTMSA electrolyte at 0.5 mA cm⁻² and 1 mAh cm⁻². The inset in FIG. 5A shows a closer view of the CE values for the cell cycled in 1 m LiFSI/DMTMSA electrolyte. The cell with 1 m LiFSI/DMTMSA electrolyte had an average CE of ˜99% over 345 cycles, much higher than that of the conventional electrolyte.

FIG. 6B shows cycling stability of the LMA in LiFSI/DMTMSA electrolyte demonstrated by Li plating/stripping in symmetric cells at 0.5 mA cm⁻² and 1.5 mAh cm⁻² using conventional or 1 m LiFSI/DMTMSA electrolyte. The cells with LiFSI/DMTMSA electrolyte showed much less polarization than the cells using the conventional electrolyte. These results indicate that the LiFSI/DMTMSA electrolyte is compatible with the LMA and facilitates stable cycling of the LMA.

The Li deposition morphology is critical to LMA reversibility. Using a conventional electrolyte, after long-term cycling, the thickness of the LMA increases due to Li metal morphological instability. The thicker LMA includes SEIs, trapped gases, and liquid-infilled porosity. A less-compact, less-active layer, formed by dead Li, SEIs, and high porosity, together with depleted Li inventory and liquid electrolyte (also contaminated), can lead to impedance growth and pre-mature cell failure on the anode side. The Li metal morphological instability is also a safety risk, increasing the likelihood of short-circuiting and/or thermal run away.

FIGS. 6C and 6D show SEM images of the cross-sectional views of the LMA collected from Li∥NMC811 cells after 100 cycles at 0.5 C with conventional electrolyte and LiFSI/DMTMSA electrolyte, respectively. After cycling in the conventional electrolyte, active Li in the LMA was completely consumed and the LMA had undergone a large volume expansion, from an initial thickness of 60 μm to about 250 μm after cycling. In contrast, the thickness increase in the LMA cycled in LiFSI/DMTMSA electrolyte was an order of magnitude less, and the less-compact layer was only about 26 μm thick after cycling. The Li particles remained larger, uniform, and compact in the LiFSI/DMTMSA electrolyte, while whisker-like Li deposits with high porosity were observed in the LMA cycled in the conventional electrolyte.

FIGS. 6E and 6F show XPS elemental analysis of the SEI layers from the LMAs in FIGS. 6C and 6D. Different SEI compositions formed in the different electrolytes. The SEI derived from the sulfonamide-based electrolyte was mainly composed by inorganic components including LiF and lower-valence sulfur (S⁻/S²⁻) species, which are preferable SEI components, while that derived from the carbonate reference electrolyte was abundant with organic components. Compared to the C—C and C—O/C═O groups in carbonates, the sulfonamide group (CF₃SO₂N—) facilitates the donation of F and S to the highly reductive Li to form more favorable SEIs.

Full-Cell Performance Under Practical Conditions

To increase performance of the full-cell LMB, a high-loading cathode, lean electrolyte, and a small amount of LMA may be used simultaneously. These conditions are practical for industrial batteries, but they are not conducive to stable cycling at high voltage in conventional electrolyte. However, the LiFSI/DMTMSA electrolyte facilitates stable cycling under these practical conditions.

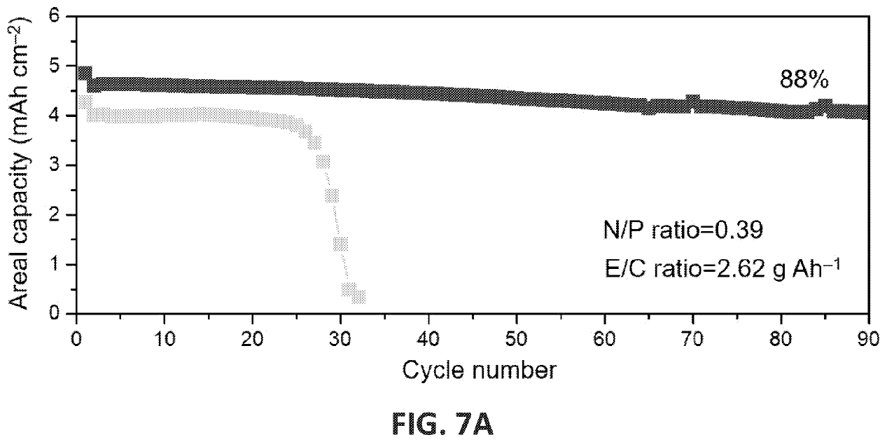

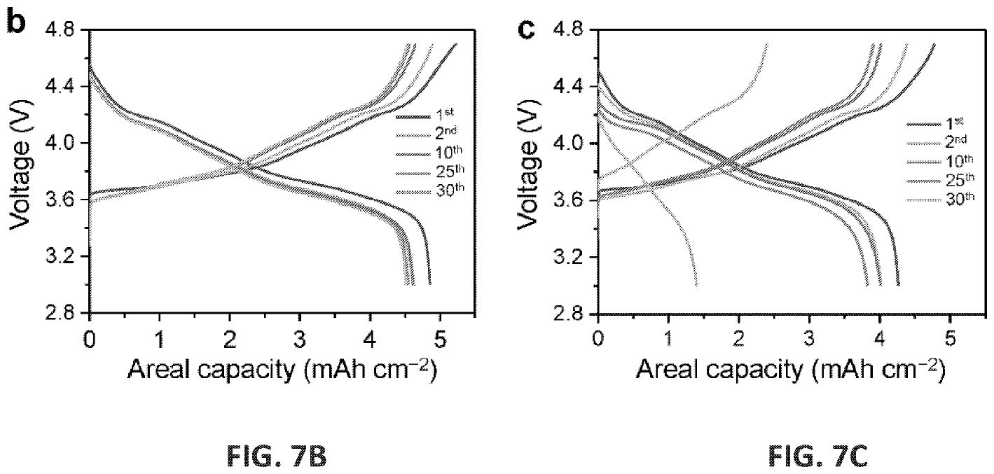

FIG. 7A compares electrochemical performance of Li∥NMC811 cells under practical conditions in conventional electrolyte and LiFSI/DMTMSA electrolyte. FIGS. 7B and 7C show voltage profiles from the cycling data in FIG. 7A in LiFSI/DMTMSA electrolyte and conventional electrolyte, respectively. The cells were cycled with a high upper cut-off voltage of 4.7 V vs. Li⁺/Li. The discharging/charging rates were 0.1 C/0.1 C for the 1^{st} cycle and 0.5 C/0.15 C afterward. For 1 m LiFSI/DMTMSA electrolyte, the N/P and E/C ratios were ˜0.39 and ˜2.62 (g Ah⁻¹). For 1 M LiPF₆/EC-EMC+2% VC electrolyte, N/P ratio was ˜2.8 (60 μm Li foil was used) and E/C ratio was ˜5 g Ah⁻¹.

When using the conventional electrolyte, LMBs with high-loading NMC811 cathodes (˜4.25 mAh cm⁻²), thin Li foil (60 μm, N/P ratio ˜2.82), and limited electrolyte (E/C ratio ˜5 g Ah⁻¹) can only survive 25 cycles. In the conventional electrolyte, uncontrolled side reactions rapidly deplete Li and/or electrolyte and cause catastrophic capacity decay. In contrast, even under harsher conditions (cathode loading of ˜4.86 mAh cm⁻², N/P ratio of ˜0.39, E/C ratio of ˜2.62 g Ah⁻¹), the 1 m LiFSI/DMTMSA electrolyte facilitated improved cycling stability in LMBs cycling to 4.7 V vs. Li⁺/Li. The LMBs using LiFSI/DMTMSA electrolyte had an 88% capacity retention after 90 cycles at a 0.5 C/0.15 C discharge/charge rate.

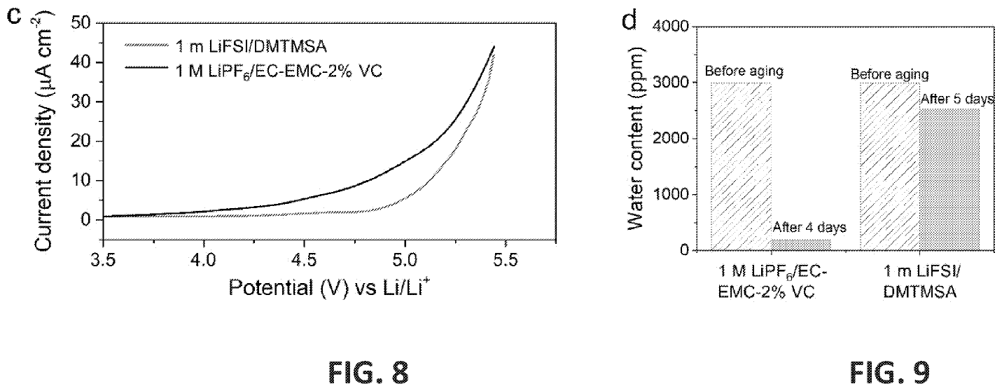

FIG. 8 compares electrochemical stability of the conventional electrolyte and the LiFSI/DMTMSA electrolyte. The electrochemical stability of electrolytes was evaluated by linear sweep voltammetry (LSV) method at a scan rate of 10 mV s⁻¹ using configuration. The stability of the Al current collector was measured in different electrolytes at high voltages using a configuration and holding the potential at 4.7 V for 10 hr. The LiFSI/DMTMSA electrolyte showed increased electrochemical stability at voltages between 4.5 and 5.0 V vs Li⁺/Li as compared to the conventional electrolyte.

The linear sweep voltammetry (LSV) experiments used a scan rate of 10 mV s⁻¹ and a Li∥Al configuration. The stability of the Al current collector in different electrolytes at high voltages was measured by Li∥Al configuration while holding the potential at 4.7 V for 10 hours. Then the Al foils were collected and characterized by SEM and XPS.

FIG. 9 compares water concentration in conventional electrolyte and the LiFSI/DMTMSA electrolyte. The results show the amount of water each electrolyte before and after aging with 3000 ppm of water for 4 or 5 days. The results showed that much of the added water was still present in the LiFSI/DMTMSA electrolyte after 5 days, indicating that the water did not react with the electrolyte. In comparison, little of the water remained in the conventional electrolyte after 4 days due to chemical reaction. These results indicate that the LiFSI/DMTMSA electrolyte is less susceptible to degradation from hydrolysis than conventional electrolytes.

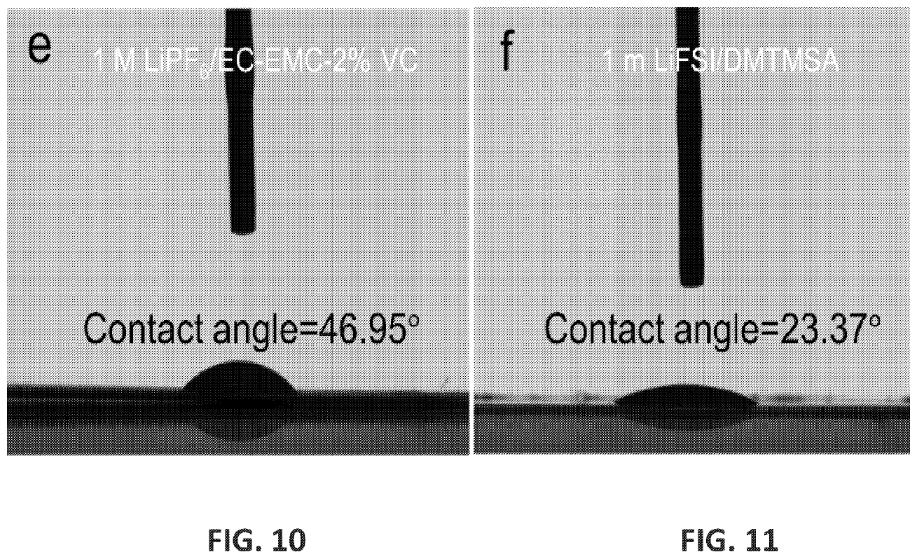

FIGS. 10 and 11 show contact angle measurements of conventional electrolyte and LiFSI/DMTMSA electrolyte, respectively, on a Celgard 2325 separator. The contact angle for the conventional electrolyte was 46.95°. The contact angle for the conventional electrolyte was 23.37°. The lower contact angle for the LiFSI/DMTMSA electrolyte indicates that this electrolyte more readily wets the separator than the conventional electrolyte.

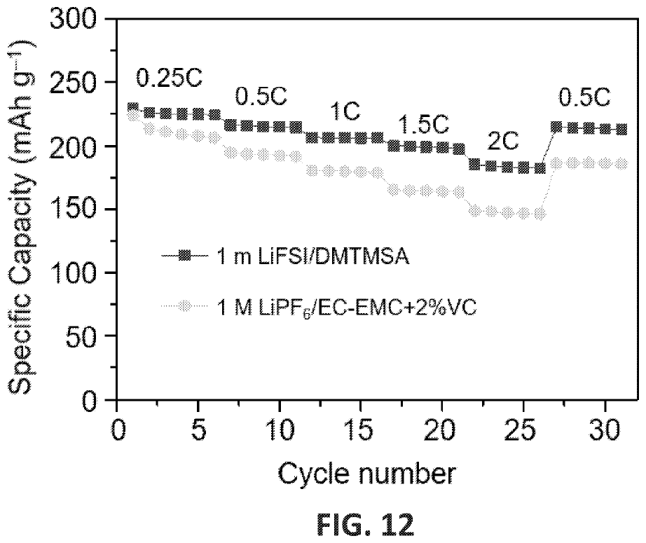

FIG. 12 shows rate performance of Li∥NMC811 cells using 1 m LiFSI/DMTMSA and 1 M LiPF₆/EC-EMC-2% VC electrolytes. The LiFSI/DMTMSA electrolyte improves rate capability, offering high capacities of 205 mAh g⁻¹ at 1 C and 186 mAh g⁻¹ at 2 C.

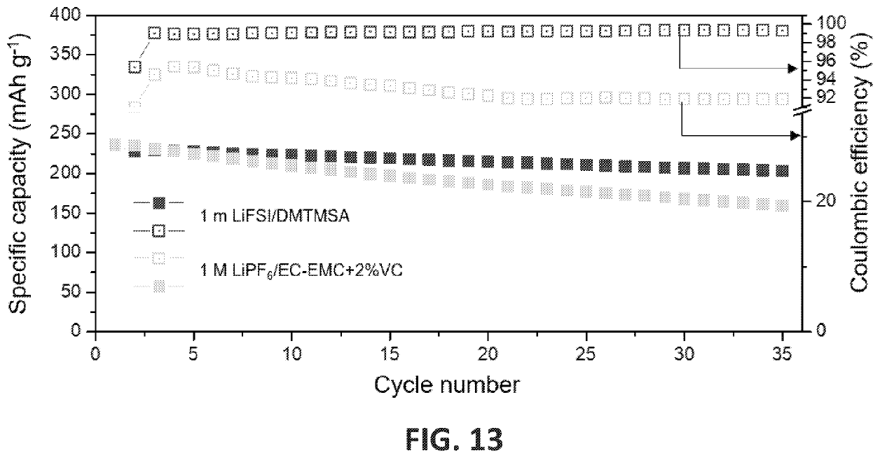

FIG. 13 shows high-temperature (55° C.) cycling performance of the Li∥NMC811 cells using 1 m LiFSI/DMTMSA and 1 M LiPF₆/EC-EMC+2% VC at 0.5 C. The cells were cycled between 3 V to 4.7 V vs. Li⁺/Li. The LMBs with the LiFSI/DMTMSA electrolyte exhibited excellent CEs of >99% even when cycled at 55° C., compared to CEs of ˜92% for the conventional electrolyte.

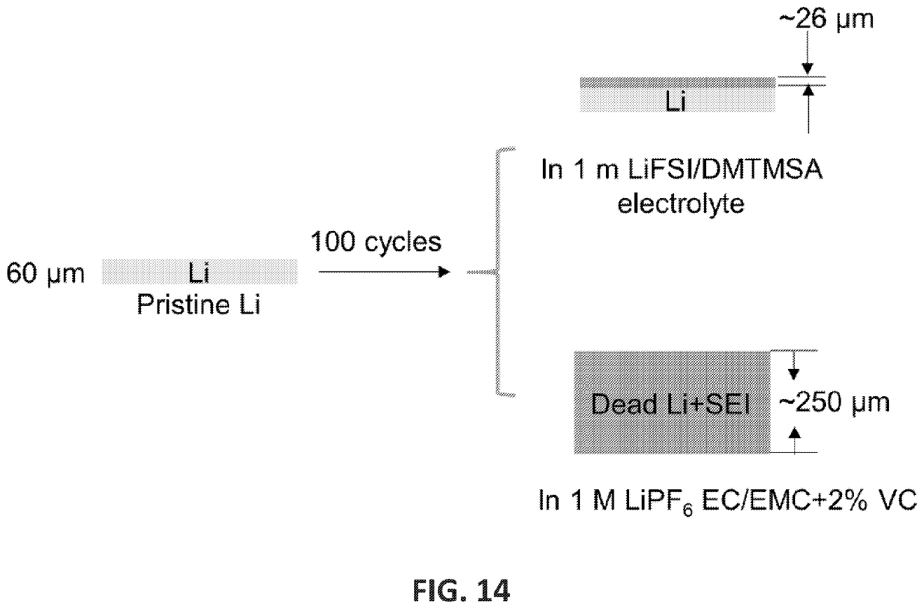

FIG. 14 shows a schematic of the structure of the Li foil after 100 cycles in Li∥NMC811 cells with different electrolytes. 60 μm-thick Li foil was used. The thickness of the “garbage” layer cycled in the carbonate conventional electrolyte was ˜250 μm while that cycled in the sulfonamide-based electrolyte was only ˜26 μm.

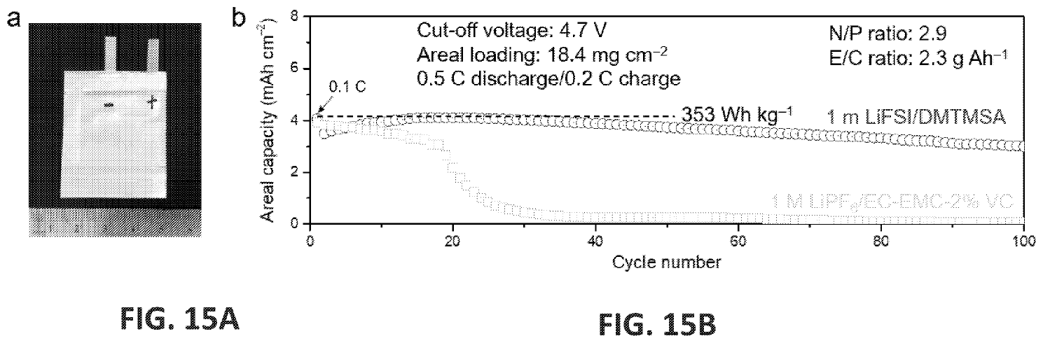

FIG. 15A shows a Li∥NMC811 pouch cell and FIG. 15B shows cycling performance of Li∥NMC811 pouch cells with 1 m LiFSI/DMTMSA and 1 M LiPF₆/EC-EMC-2% VC electrolytes. Single-layer pouch cells were assembled by hand-stacking the NMC811 cathode, Li foil (on Cu current collector) and separator followed by electrolyte injecting and vacuum sealing. The pouch cells were cycled at 0.5 C/0.2 C discharge/charge rates. The upper cut-off voltage was 4.7 V vs. Li⁺/Li. Active material loading in the cathode was 18.4 mg cm⁻². E/C and N/P ratios were 2.3 g Ah⁻¹ and 2.9, respectively.

The pouch cell with the LiFSI/DMTMSA electrolyte stably delivered a specific energy of 353 Wh kg⁻¹ based on the pouch cell weights listed in Table 3, while the pouch cell with the conventional electrolyte rapidly degraded within 20 cycles. Adapting the parameters of demonstrated multilayer pouch cells, a cell-level specific energy of 417 Wh kg⁻¹ was estimated in Table 4, which is encouraging for future development and large-scale production which reduces the cost (the present material costs are listed in Table 5) of the sulfonamide electrolyte for practical high-voltage Li∥NMC811 batteries.

TABLE 3
Parameters used for calculating the specific
energy of the single-layer pouch cell

| Component | Weight (mg) |
|---|---|
| Cathode | 109.9 |
| Anode | 47.9 |
| Separator | 6.1 |
| Electrolyte | 43.5 |
| Total weight (mg) | 207.4 |

TABLE 4
Parameters used for estimating the specific energy
in multilayer pouch cell configuration *

| | | | | | | Total |
|---|---|---|---|---|---|---|
| | | | Areal weight | | Area | weight |
| Component | Parameters | | (mg cm⁻²) | Layers | (cm²) | (mg) |
| Cu | 6 | μm | 5.37 | 10 | 31.5 | 1691.6 |
| Al | 12 | μm | 3.24 | 10 | 31.5 | 1020.6 |
| NMC811 cathode | ~96 | μm | 19.6 | 19 | 31.5 | 11730.6 |
| Li | 60 | μm | 3.22 | 19 | 31.5 | 1927.2 |
| Separator | 16 | μm | 1.32 | 19 | 31.5 | 790.0 |

| | | |
|---|---|---|
| Electrolyte | E/C ratio = | 5655.6 |
| | 2.3 g Ah⁻¹ | |

TABLE 5
Costs of the chemicals used for DMTMSA solvent synthesis *

| | Role | Grade | Price | Vendor |
|---|---|---|---|---|
| Dimethylamine | Raw material | ≥99% | $303/kg | Sigma Aldrich |
| Trifluoromethanesulfonyl | Raw material | ≥99.0% | $4935/kg | Fisher Scientific |
| chloride | | | | |
| Dichloromethane | Solvent | ≥99.8% | $40.5/L | Sigma Aldrich |
| Tetrahydrofuran | Solvent | ≥99.0% | $40.3/L | Sigma Aldrich |
| Triethylamine | Removing | For synthesis | $14.7/kg | Sigma Aldrich |
| | byproduct | | | |
| | HCl | | | |

* $ is US dollar

One advantage of the present invention is its greatly improved electrochemical performance offered by the 1 m LiFSI in DMTMSA electrolyte. The electrolyte successfully modified cathode/anode-electrolyte interactions with suppressed side reactions. On the anode side, weakly solvating electrolyte may weaken Lit solvent interaction while promoting Li⁺-anion interactions. This creates more anion-derived SEIs, which are believed to benefit graphite and LMA. The solvent DMTMSA has a weak solvation ability to salts because of its low polarity, which together with the benefits of LiFSI makes the 1 m LiFSI/DMTMSA electrolyte highly compatible with LMA.

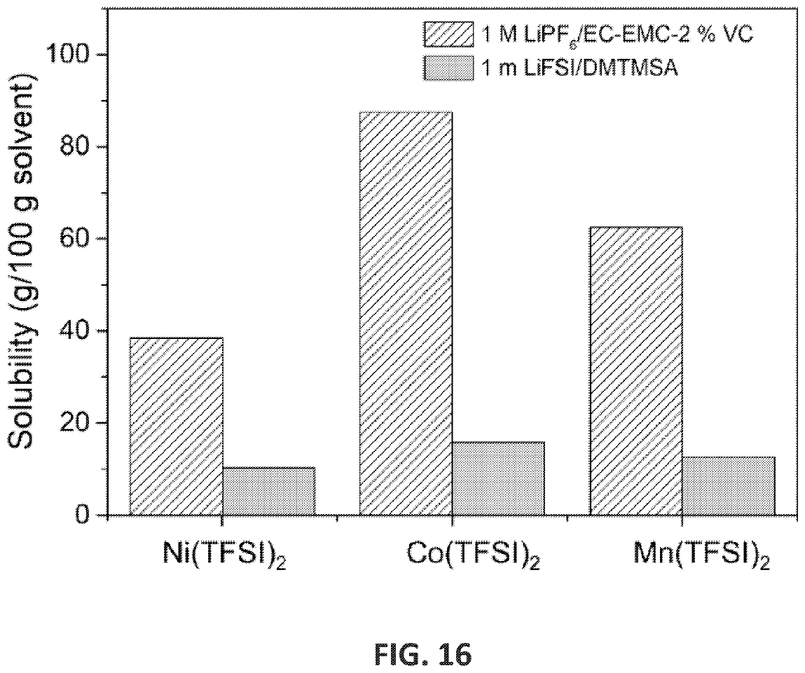

FIG. 16 shows the solubilities of Ni(TFSI)₂, Co(TFSI)₂ and Mn(TFSI)₂ in 1 m LiFSI/DMTMSA and 1 M LiPF₆/EC-EMC with 2% VC. The LiFSI/DMTMSA electrolyte has lower salt solubility in general compared to conventional carbonate electrolyte, which has a higher polarity. Specifically, LiFSI/DMTMSA electrolyte has low solubility to Ni(TFSI)₂, Co(TFSI)₂ and Mn(TFSI)₂ with similar TFSI group to the DMTMSA (FIG. 32). The LiFSI/DMTMSA electrolyte may also have low solubilities for Ni²⁺, Co²⁺, and Mn²⁺ salts with other anion groups.

It is possible that Al corrosion is suppressed in the LiFSI/DMTMSA electrolyte. LiFSI is known to corrode Al current collector, which limits its practical use. The LiFSI/DMTMSA electrolyte may suppress Al corrosion by forming a AlOₓF_{y}-like passivation layer at the surface of the Al current collector, similar to that formed in LiPF₆-based electrolytes, which do not have Al corrosion problems.

To summarize the results with the exemplary NMC811 cathode, the sulfonamide-based electrolyte (1 m LiFSI in DMTMSA) paired with ultra-high-voltage NMC811 cathodes displays superior cycling stability under harsh conditions. On the cathode side, the electrolyte can successfully facilitate the stable cycling of 4.7 V NMC811, delivering a specific capacity >230 mAh g⁻¹ and an average Coulombic efficiency >99.65% over 100 cycles. The electrolyte effectively stabilizes the NMC811 cathode surface, thus suppressing the rates of side reactions, gas evolution, and transition-metal dissolution. Detailed surface characterizations also suggest the formation of more LiF-like inorganic components inside the CEIs derived from our electrolyte compared to a commercial carbonate reference electrolyte. Moreover, the delayed intergranular SCC of NMC811 preserves electronic contacts between primary particles and prevents the need of more liquid electrolyte for wetting mode-I crack-generated fresh surfaces. On the LMA side, the electrolyte shows excellent compatibility with desirable deposition morphology and decreased Li-metal pulverization. Benefiting on both electrodes of the full cell, the 1 m LiFSI/DMTMSA electrolyte facilitated good cycling stability of ultra-high-voltage LMBs under industrially practical, harsh conditions.

1 m LiFSI/DMTMSA Facilitates Stable Cycling of Lithium Cobalt Oxide (LCO) Cathode with an Upper Cutoff Voltage of 4.55 V

The electrochemical performance of LiCoO₂ cathode was evaluated at an upper cut-off voltage of 4.55 V vs. Li/Li⁺ with different electrolytes.

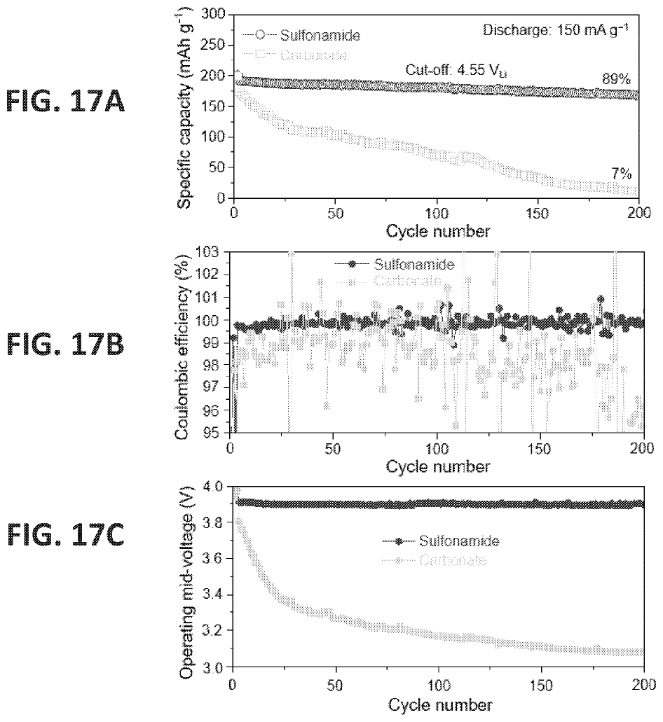

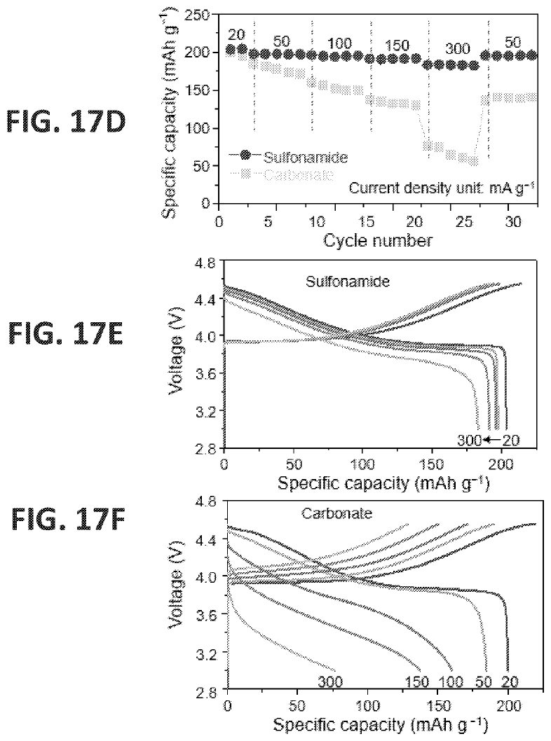

FIGS. 17A-17F show electrochemical performance of Li∥LCO cells with conventional carbonate electrolyte or 1 m LiFSI/DMTMSA electrolyte. FIGS. 17A-17C show the specific capacities, Coulombic efficiencies (CE), and operating mid-voltages, respectively, of Li∥LCO cells as a function of cycle number with the different electrolytes. The upper cut-off voltage was 4.55 V vs Li/Li⁺. The current densities during charging and discharging were 50 mA g⁻¹ and 150 mA g⁻¹, respectively. 10 mA g⁻¹ charging-discharging was used for the 1^{st} cycle. FIG. 17D shows rate performance of Li∥LCO cells with a 4.55 V cut-off voltage and corresponding voltage profiles with the sulfonamide and carbonate electrolytes in FIGS. 17E and 17F, respectively.

As shown in FIG. 17A, the discharge capacity during the 1^{st} cycle with 1 m LiFSI/DMTMSA electrolyte reached 200.8 mAh g⁻¹ with an excellent capacity retention of 89% after 200 cycles. In contrast, with 1.2 M LiPF₆/EC-EMC electrolyte, the cell only exhibited a capacity retention of 7% after 200 cycles. The CE and operating mid-voltage were also maintained very high and stable with the LiFSI/DMTMSA electrolyte. FIGS. 17-17F show the cell with the LiFSI/DMTMSA electrolyte exhibits much better rate performance than the one with the carbonate electrolyte. These results indicate that the LiFSI/DMTMSA electrolyte may greatly improve the electrochemical performance of the LCO cathode even at a high charging voltage like 4.55 V.

Improving the Stability of the Graphite Anode

LiFSI/DMTMSA electrolyte is compatible with and facilitates stable electrochemical cycling performance with graphite anodes. In order to evaluate the compatibility of LiFSI/DMTMSA electrolyte, Li∥graphite half-cells with LiFSI/DMTMSA were tested.

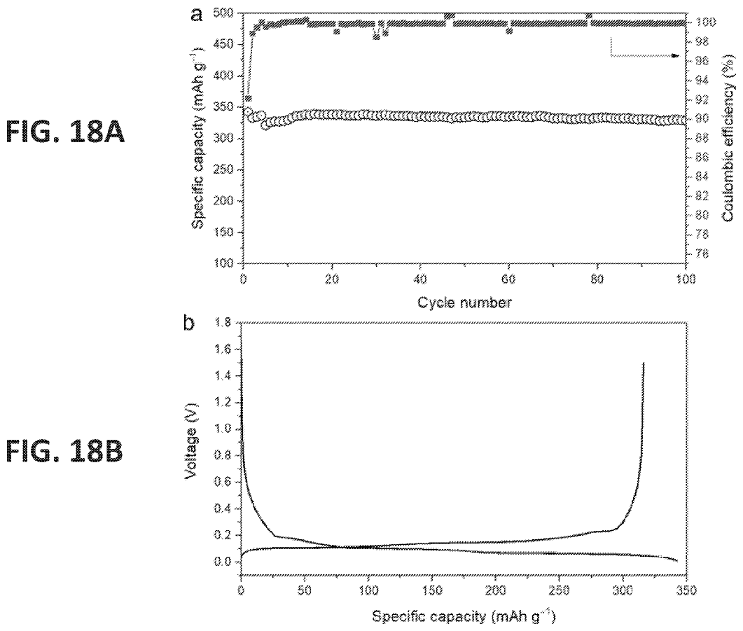

FIG. 18A shows electrochemical performance of a Li∥graphite half-cell using 1 m LiFSI/DMTMSA electrolyte. FIG. 18B shows a voltage profile from the cycling data in FIG. 18A. Areal loading was about 3.6 mg cm⁻². The voltage window was 0.01 V to 1.5 V vs. Li⁺/Li. The half-cell was cycled at a rate of 0.1 C for the 1st cycle, 0.2 C for the 2^{nd} cycle to the 4^{th} cycle, and 0.4 C for the rest of the cycles. The results show that the Li∥graphite half-cell exhibits a stable cycling performance with nearly 100% capacity retention after 100 cycles and a high CE of 92.22%. These results are similar to those of commercial carbonate electrolytes.

The cycling stability of the graphite anode in LiFSI/DMTMSA electrolyte can be further improved by adding one or more additives to the electrolyte (e.g., present in an amount of 0.1% to 30% by weight). For example, adding fluoroethylene carbonate (FEC) as a co-solvent (DMTMSA:FEC=9:1 weight ratio), the cycling stability of graphite may be better than the 1 m LiFSI in DMTMSA electrolyte alone. Prop-1-ene-1,3-sultone (PST) may also be used an additive (e.g., 2% by weight) in the electrolyte to improve cycling stability. 1,1,2,2-tetrafluoroethyl-2,2,3,3-tetrafluoropropyl ether (TTE) may also be used as co-solvent or additive (e.g., present in an amount of 0.1% to 30% by weight, including 2%, 16% and 30% by weight). Lithium difluoro(oxalato)borate (LiDFOB) may also be used as an additive. In some cases, several different additives may be added to the electrolyte. For example, TTE, FEC, and LiDFOB may all be used as additives in the electrolyte.

Li—S Batteries with a Sulfonamide-Based Electrolyte with Ether as Co-Solvent

A good electrolyte for lithium-sulfur (Li—S) batteries may have good compatibility with Li metal and suitably low polysulfide solubility to suppress the shuttling effect. The shuttling effect may contribute to a low Coulombic efficiency (CE). However, if the electrolyte's polysulfide solubility is too low, the electrolyte may limit sulfur utilization. The DMTMSA solvent has very low polysulfide solubility and good compatibility with Li metal.

A co-solvent with higher polysulfide solubility may be added to the DMTMSA electrolyte to create an electrolyte with a suitable polysulfide solubility for Li—S batteries. For example, dimethoxyethane (DME), 1,3-dioxolane (DOL), and/or tetraethylene glycol dimethyl ether (TEGDME) may be added as a co-solvent. The co-solvent may be present in the electrolyte in a concentration of about 5% to about 50% (e.g., 5%, 10%, 15%, 20%, 25%, 30%, 35%, 40%, 45%, or 50%).

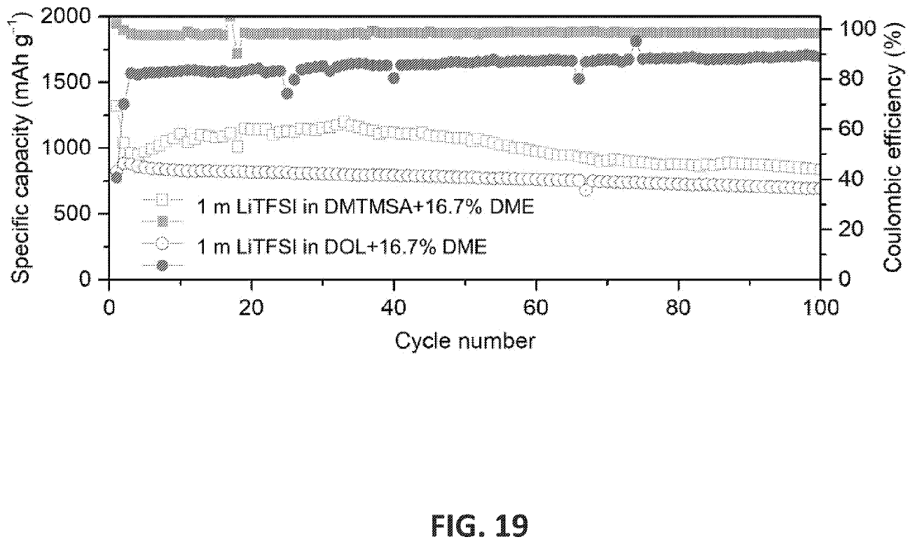

FIG. 19 shows electrochemical performance of Li—S cells with 1 m lithium bis(trifluoromethanesulfonyl)imide (LiTFSI) in DMTMSA with 16.7% dimethoxyethane (DME) and 1 m LiTFSI in 1,3-dioxolane (DOL) with 16.7% DME. LiTFSI may be present in the electrolyte in a concentration of about 0.2 m to about 3 m (e.g., 0.2 m, 0.4 m, 0.5 m, 0.6 m, 0.8 m, 1.0 m, 2.0 m, 2.5 m, or 3.0 m). LiTFSI was used because LiFSI may react with the sulfur cathode. The DOL-based electrolyte is a conventional electrolyte used in Li—S batteries. The 1 m LiTFSI in DMTMSA+16.7% DME exhibited a high initial capacity and high CE ˜98% and a good capacity retention after 100 cycles, demonstrating suppression of the shuttling effect without compromising the sulfur utilization. In contrast, the cell with the conventional 1 m LiTFSI in DOL+16.7% DME electrolyte exhibited a low initial capacity and poor CE ˜80%, indicating a severe shuttling effect.

Synthesis of DMTMSA

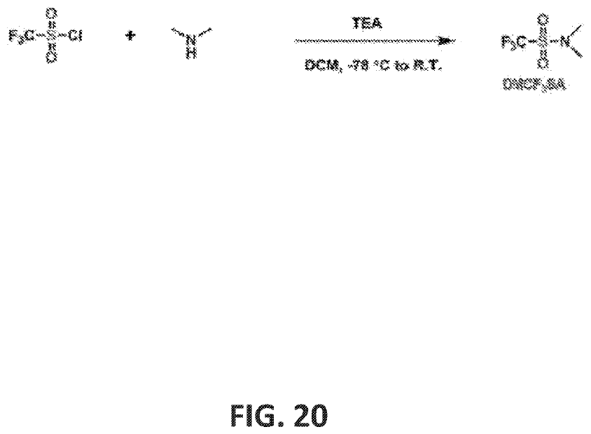

FIG. 20 shows an example synthesis scheme for making the aprotic solvent DMTMSA. The reactants were dimethylamine and trifluoromethanesulfonyl chloride. The reactants were mixed in triethylamine (TEA) and dichloromethane (DCM) solvents. The mixture was cooled to −78° C. under nitrogen and then brought to room temperature.

### CONCLUSION

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize or be able to ascertain, using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

Also, various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of” “only one of” or “exactly one of.” “Consisting essentially of” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1. An electrochemical device comprising:
a cathode comprising at least one transition metal oxide; and
an electrolyte comprising:
a solvent comprising N, N-dimethyltrifluoromethane-sulfonamide (DMTMSA); and
lithium bis(fluorosulfonyl)imide (LiFSI) substantially dissolved in the solvent.

2. The electrochemical device of claim 1, wherein the DMTMSA and LiFSI are present in the electrolyte in a weight percent of about 80% to about 99% of the electrolyte.

3. The electrochemical device of claim 1, wherein the DMTMSA and LiFSI are present in the electrolyte in a weight percent of about 1% to about 20% of the electrolyte.

4. The electrochemical device of claim 1, wherein the at least one transition metal oxide comprises LiNiₓMn_{y}Co_{z}O₂, and x+y+z=1.

5. The electrochemical device of claim 4, wherein x is about 0.8, y is about 0.1, and z is about 0.1.

6. The electrochemical device of claim 1, wherein the LiFSI is present in the electrolyte at a concentration of about 0.2 to about 5.0 moles of LiFSI per kilogram of the solvent.

7. The electrochemical device of claim 6, wherein the LiFSI is present in the electrolyte at a concentration of about 1.0 mole of LiFSI per kilogram of the solvent.

8. The electrochemical device of claim 1, wherein the electrochemical device additionally comprises a lithium metal anode.

9. The electrochemical device of claim 1, wherein the electrochemical device additionally comprises a hard carbon anode.

10. The electrochemical device of claim 1, wherein the electrochemical device additionally comprises a graphite anode.

11. The electrochemical device of claim 1, wherein the electrolyte additionally comprises at least one of:
fluoroethylene carbonate (FEC);
1,1,2,2-tetrafluoroethyl-2,2,3,3-tetrafluoropropyl ether (TTE);
prop-1-ene-1,3-sultone (PST);
vinylene carbonate (VC);
ethylene carbonate (EC);
lithium bis(oxalato)borate (LiBOB);
lithium difluoro(oxalato)borate (LiDFOB); or
tris(trimethylsilyl)phosphite (TMSPi).

12. A method of using a battery, the method comprising:
(A) charging the battery to at least 4.7 V±0.05 vs. Li/Li⁺;
(B) discharging the battery to about 3.0±0.2 V vs. Li/Li⁺;
(C) repeating steps (A) and (B) for at least 100 cycles at room temperature,
wherein:
the battery has an initial specific discharge capacity of at least about 231 mAh g⁻¹;
over the at least 100 cycles, the battery retains an average specific discharge capacity of at least about 88% of the initial specific discharge capacity and has an average Coulombic efficiency of at least about 99.65%; and
the battery comprises:
a cathode;
a lithium metal anode; and
an electrolyte.

13. The method of claim 12, wherein charging and discharging are performed at a 0.5 C rate.

14. The method of claim 12, wherein the electrolyte comprises:
a solvent comprising N, N-dimethyltrifluoromethane-sulfonamide (DMTMSA); and
lithium bis(fluorosulfonyl)imide (LiFSI) substantially dissolved in the solvent.

15. The method of claim 14, wherein the DMTMSA and LiFSI are present in the electrolyte in a weight percent of about 80% to about 99% of the electrolyte.

16. The method of claim 14, wherein the DMTMSA and LiFSI are present in the electrolyte in a weight percent of about 1% to about 20% of the electrolyte.

17. The method of claim 14, wherein the LiFSI is present in the electrolyte at a concentration of about 0.2 to about 5.0 moles of LiFSI per kilogram of the solvent.

18. The method of claim 12, wherein the cathode comprises LiNiₓMn_{y}Co_{z}O₂, and x+y+z=1.

19. The method of claim 18, wherein x is about 0.8, y is about 0.1, and z is about 0.1.

20. An electrochemical device comprising:
a cathode comprising sulfur; and
an electrolyte comprising:
a solvent comprising N, N-dimethyltrifluoromethane-sulfonamide (DMTMSA) and dimethoyxethane (DME); and
lithium bis(trifluoromethanesulfonyl)imide (LiTFSI) substantially dissolved in the solvent.
